(19) United States
(12) Patent Application Publication
(10) Pub. No.: US 2006/0156355 A1
(43) Pub. Date: Jul. 13, 2006

(54) Reproduction apparatus, program, integrated circuit

(76) Inventors: Masahiro Kawasaki, Hiroshima-shi (JP); Akihiro Watanabe, Higashihiroshima-shi (JP); Shuji Okamoto, Kure-shi (JP); Yuji Iwahara, Higashihroshima-shi (JP); Tohru Suetomo, Higashihroshima-shi (JP); Yasuyuki Matuura, Higashihiroshima-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/546,530

(22) PCT Filed: Jun. 10, 2004
(86) PCT No.: PCT/JP04/08469

§ 371 Date: Aug. 23, 2005

(30) Foreign Application Priority Data
Jun. 11, 2003 (JP) 2003-167055

(51) Int. Cl. H04N 7/173; H04N 7/00; H04N 5/91

(52) U.S. Cl. 725/88; 725/102; 386/46

(57) ABSTRACT

A reproduction apparatus that, when a same content is recorded in the HDD 1 and the SD card 102, allows the user to reproduce the content in one of the recording mediums to a certain viewing position and resume the reproduction of the content in the other recording medium from the certain viewing position (resume position), without causing the user to view a portion of the content redundantly. When the SD card 102 is inserted into the reproduction apparatus, the resume information of the HDD 1 and the SD card 102 is updated to synchronize the viewing position of the HDD 1 with the viewing position of the SD card 102, allowing the user to resume reproduction from the viewing position indicated by the updated resume information and saving the user from viewing a portion redundantly.

### TECHNICAL FIELD

The present invention generally relates to a reproduction apparatus, a program, and an integrated circuit for reproducing a video content, and mote particularly, relates to a technology for allowing a user to view a video content recorded in a mobile medium.

### BACKGROUND ART

In recent years, attempts have been made to provide reproduction apparatuses that support functions connected with mobile devices. Reproduction apparatuses encode broadcast contents into the MPEG2 format and record the encoded (compressed) contents onto hard disks embedded in the reproduction apparatuses. On example of functions connected with mobile devices of the reproduction apparatuses is to encode a broadcast content into the MPEG4 format and record the encoded content into an SD card.

The MPEG4 format has an algorithm that is different from that of the MPEG2 format, and has an encoding bit rate that is far lower than that of the MPEG2 format. The low encoding bit rate enables the SD card, which has a capacity of as small as 256 megabytes, to record therein a video content of one hour or two hours of playing time.

With such an SD memory card in which a video content is recorded, users can reproduce and view the content on a PDA or mobile phone. This enables the users to view, for example, news programs on the way to work or in spare moments from their work. As apparent from this, such a function increases the convenience of users since it enables the users to view a video content regardless of place or time.

Meanwhile, when contents having a sameness (for example, contents one of which has been copied from the other, with the encoding bit rate converted into a different one) are respectively recorded into an SD card and a hard disk, the user may advance a viewing position of a content in one of the two recording mediums further than a content in the other. If the user tends to go out frequently and has more time outside than at home to view the content, the viewing position in the SD card is expected to advance further than in the hard disk. If the user tends to spend a considerable proportion of time at home, the viewing position in the hard disk will progress further. It depends on the lifestyle of the user. In any event, in such a case where contents are respectively recorded on different recording mediums and have differently advanced viewing positions, it often happens that even if a user has already viewed a portion of a content in one recording medium, the user has to view the portion once again in the other recording medium. In regards with such a case, one might think, “Why not view the content in the SD card at home so he/she can view the content in proper succession”. However, when a content is copied from the hard disk to the SD card, the encoding bit rate is converted from MPEG2 to MPEG4. This means that the image quality of the content in the SD card may be lower than that in the hard disk. In general, users do not prefer to view a video content with a low image quality if they can view the same with a high image quality.

### DISCLOSURE OF THE INVENTION

It is the object of the present invention to provide a reproduction apparatus that, when a same content is recorded in different recording mediums, allows the user to reproduce the content in one of the recording mediums to a certain viewing position and resume the reproduction of the content in the other recording medium from the certain viewing position (resume position), without causing the user to view a portion of the content redundantly.

The first object can be achieved by a reproduction apparatus comprising: an embedded recording medium storing therein a first video content and first resume position information that indicates a resume position of the first video content; a connecting unit operable to connect to a mobile recording medium; a judging unit operable to, if the mobile recording medium connected to the connecting unit stores therein a second video content and second resume position information that indicates a resume position of the second video content, judges whether the first and second video contents have a sameness; an update unit operable to, if the judging unit judges that the first and second video contents have the sameness, update either the first or the second resume position information to synchronize the resume position of the embedded recording medium with the resume position of the mobile recording medium; and a reproduction unit operable to reproduce the first or second video content starting from the resume position indicated by the first or second resume position information after the update.

With the above-described construction, when two contents having a sameness are respectively recorded on the embedded and mobile recording mediums, the update unit updates the resume position information to synchronize the resume position between the embedded recording medium and the mobile recording medium. As a result, even if the resume position in the embedded or mobile recording medium advances further than that in the other recording medium, the resume position is synchronized and the user need not view a portion of the content redundantly.

In the above reproduction apparatus, the embedded recording medium stores therein first recording date/time information that indicates a recording date/time of the first video content, the second video content stored in the mobile recording medium is a copy of the first video content stored in the embedded recording medium, the mobile recording medium stores therein second recording date/time information that indicates a recording date/time at which the first video content as an original of the second video content was recorded in the embedded recording medium, and the judgment performed by the judging unit includes a judgment on whether the recording date/time indicated by the first recording date/time information matches the recording date/time indicated by the second recording date/time information.

With the above-described construction in which the recording date/time is used as a parameter to judge whether the contents have a sameness, the reproduction apparatus can judge with ease and reliability whether there is a sameness between a content stored in the embedded recording medium of the reproduction apparatus and a copy of the content.

The above reproduction apparatus may further comprise a copying unit operable to copy the first video content stored in the embedded recording medium, wherein the embedded recording medium stores therein an identifier of a recording medium to which the first video content is copied, and the judgment performed by the judging unit includes a judgment on whether the identifier stored in the embedded recording medium matches an identifier of the mobile recording medium connected to the connecting unit.

With the above-described construction, the identifier of the recording medium is used as a parameter to judge whether the contents have a sameness. With this construction, if a same content is copied into a plurality of mobile recording mediums, the reproduction apparatus can judge whether there is a sameness between a content stored in the embedded recording medium of the reproduction apparatus and each of the plurality of mobile recording mediums.

In the above reproduction apparatus, the embedded recording medium may store therein a plurality of identifiers of a plurality of recording mediums to which the first video content is copied, each of the plurality of identifiers is correlated with a piece of resume position information which corresponds to one of a plurality of users, the judging unit judges that the first and second video contents have the sameness if an identifier of the mobile recording medium connected to the connecting unit is included in the plurality of identifiers stored in the embedded recording medium, and if the judging unit judges that the first and second video contents have the sameness, the update unit updates either the first resume position information or the second resume position information, which is correlated with the identifier of the recording medium connected to the connecting unit.

With the above-described construction in which a plurality of sets of resume position information and a copy history are recorded for each recorded content, and the resume position information is updated for synchronization for each user, a multiuser support environment is constructed.

The above reproduction apparatus may further comprise a registering unit operable to register, as a chapter, the resume position indicated by one of the first and the second resume position information stored in one of the embedded recording medium and the mobile recording medium, with the other of the embedded recording medium and the mobile recording medium, and if a user requests an immediate reproduction from the registered chapter using a chapter jump function, the reproduction unit reproduces the first or second video content starting from the registered chapter.

With the above-described construction in which a resume position at which the user stopped reproduction in one of the embedded and mobile recording mediums is registered with the other as a chapter, the user can immediately view, for example, a favorable scene of a movie without a rewinding operation.

In the above reproduction apparatus, when the mobile recording medium connected to the connecting unit stores therein deletion information that indicates that the second video content has been deleted, the judging unit may further judge whether the deleted second video content has the sameness with the first video content stored in the embedded recording medium, and the reproduction apparatus further comprises a deleting unit operable to delete the first video content from the embedded recording medium if the judging unit judges that the deleted second video content has the sameness with the first video content.

With the above-described construction, if a content is deleted from one of the embedded and mobile recording mediums, the content is automatically deleted also from the other recording medium. This prevents the space in the recording mediums from being unnecessarily occupied by recorded contents and copies thereof.

The above reproduction apparatus may further comprise: a resume position judging unit operable to judge whether the resume position after the synchronization indicates an end of the first or second video content; and a deleting unit operable to delete one or both of the first and second video contents from one or both of the embedded and mobile recording mediums if the resume position judging unit judges that the resume position after the synchronization indicates the end of the first or second video content.

With the above-described construction in which contents having been reproduced to the end are automatically deleted, the recording mediums are prevented from being occupied by transient broadcast contents such as news or variety show programs that are constantly broadcast, for example, on a daily or weekly basis.

### BRIEF DESCRIPTION OF THE DRAWINGS

FIG. 1 shows an example of the use form of the hard disk recorder 100.

FIG. 2A shows the construction of a recorded content in the present embodiment.

FIG. 2B shows the bit assignment for the resume information.

FIG. 3A shows an example of the copy history.

FIG. 3B shows the construction of a recorded content recorded in the HDD 1.

FIG. 3C shows the construction of a recorded content recorded in the SD card 102.

FIG. 4 shows the construction of the hard disk recorder 100.

FIG. 5 is a functional diagram of the specific means achieved by the cooperation between the program and the hardware resources.

FIG. 6A shows an example of the format of the contents navi.

FIG. 6B shows a specific example of the contents navi.

FIG. 7 is a flowchart showing processing procedures of the program stored in the microcomputer system 14.

FIG. 8 is a flowchart showing processing procedures of the program stored in the microcomputer system 14.

FIG. 9 is a flowchart showing processing procedures of the program stored in the microcomputer system 14.

FIG. 10 is a flowchart showing processing procedures of the program stored in the microcomputer system 14.

FIGS. 11A-11E show how the HDD 1, SD car 102, and SD viewer 103 are used by the user.

FIG. 12A shows the state of the HDD 1.

FIG. 12B shows the state of the HDD 1 and the SD card 102 after the recorded content is copied from the HDD 1 to the SD card 102.

FIG. 12C shows a progress in reproduction of the recorded content in the SD card 102 and the resume information updated accordingly.

FIG. 13A shows the state of the HDD 1 and the SD card 102 after the SD card 102 is re-connected to the hard disk recorder 100.

FIG. 13B shows the state of the HDD 1 and the SD card 102 after the execution of the sync operation.

FIGS. 14A-14D show a procedure in which reproduction of the recorded content further advances and the recorded content is deleted.

FIG. 15A shows the state of the HDD 1 and the SD card 102 before the sync operation is executed to synchronize the viewing position, where the resume information for the HDD 1 indicates tm1, and the resume information for the SD card 102 indicates tm2.

FIG. 15B shows a procedure in which chapters 1 and 2 are respectively registered with HDD 1 and the SD card 102.

FIG. 15C shows the state of the HDD 1 when the recorded content therein is further reproduced after the chapters 1 and 2 are registered.

FIG. 15D shows that the user can reproduce the recorded content from any desired resume position (chapter 1 or 2) in the HDD 1 or the SD card 102 by selecting a chapter jump operation.

FIG. 16A shows the construction of a content recorded in the HDD 1 in Embodiment 2.

FIG. 16B shows the construction of a content recorded in the SD card in Embodiment 2.

FIG. 17A shows an example of indication by the reproduction history information, where a position at which a normal reproduction is switched to a fast-forward is regarded as a reproduction stop position, and a position at which a fast-forward is switched to a normal reproduction is regarded as a reproduction start position.

FIG. 17B shows the reproduction periods that are obtained from the normal reproductions and fast-forwarding shown in FIG. 17A.

FIG. 17C shows an example of the reproduction history information.

FIGS. 18A-18D shows how the reproduction periods are synchronized between the HDD 1 and the SD card 102 when the reproduction periods shown in FIG. 17B are obtained.

FIGS. 19A-19C show how a recorded content is copied in Embodiment 8.

FIGS. 20A-20B show the partial deletion of content in Embodiment 9.

FIGS. 21A-21B show the resume information synchronization process in Embodiment 10.

FIGS. 22A-22B show the bookmark setting process in Embodiment 11.

FIGS. 23A-23C show the structure of the resume information for achieving the feature in which a plurality of users share one SD card 102.

### BEST MODE FOR CARRYING OUT THE INVENTION

### Embodiment 1

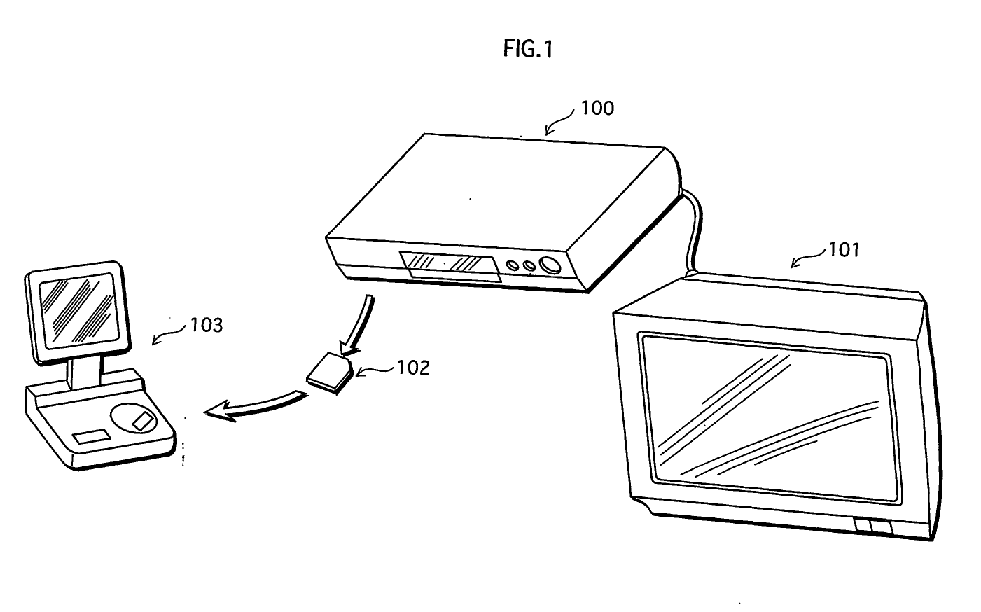

The reproduction apparatus of the present invention described in the present embodiment is a hard disk recorder which is included in a system shown in FIG. 1. First, how the hard disk recorder 100 is constructed and operated in the system will be described.

The system includes a hard disk recorder 100, a television 101, a secure digital (SD) card 102, and an SD viewer 103.

The hard disk recorder 100 receives a broadcast content, converts it into the MPEG2 format, and records the MPEG2-format content into a hard disk it has.

The hard disk recorder 100 can reproduce and delete the recorded content as well. The hard disk recorder 100 can also convert the received broadcast content into the MPEG4 format and record it into the SD card 102.

The television 101 displays the recorded content when reproduced by the hard disk recorder 100.

The SD card 102 stores the MPEG4-format content that has been converted by the hard disk recorder 100 from the received broadcast content. As described above, the content recorded in the SD card 102 is in the MPEG4 format, and the content recorded in the hard disk is in the MPEG2 format. The MPEG4 format uses a lower encoding bit rate than the MPEG2 format. As a result, the content recorded in the SD card 102 may have a lower picture quality than the content recorded in the hard disk.

The SD viewer 103 is a mobile device that can reproduce and delete the content recorded in the SD card 102.

The user can carry out the SD viewer 103 with him/her and view the broadcast content received by the hard disk recorder 100 out of doors.

Up to now, how the hard disk recorder 100 is constructed and operated has been described. The following explains the contents recorded and reproduced by the hard disk recorder 100. It should be noted here that hereinafter, contents recorded in the hard disk of the hard disk recorder 100 or in the SD card 102 in a format for reproduction are referred to as recorded contents.

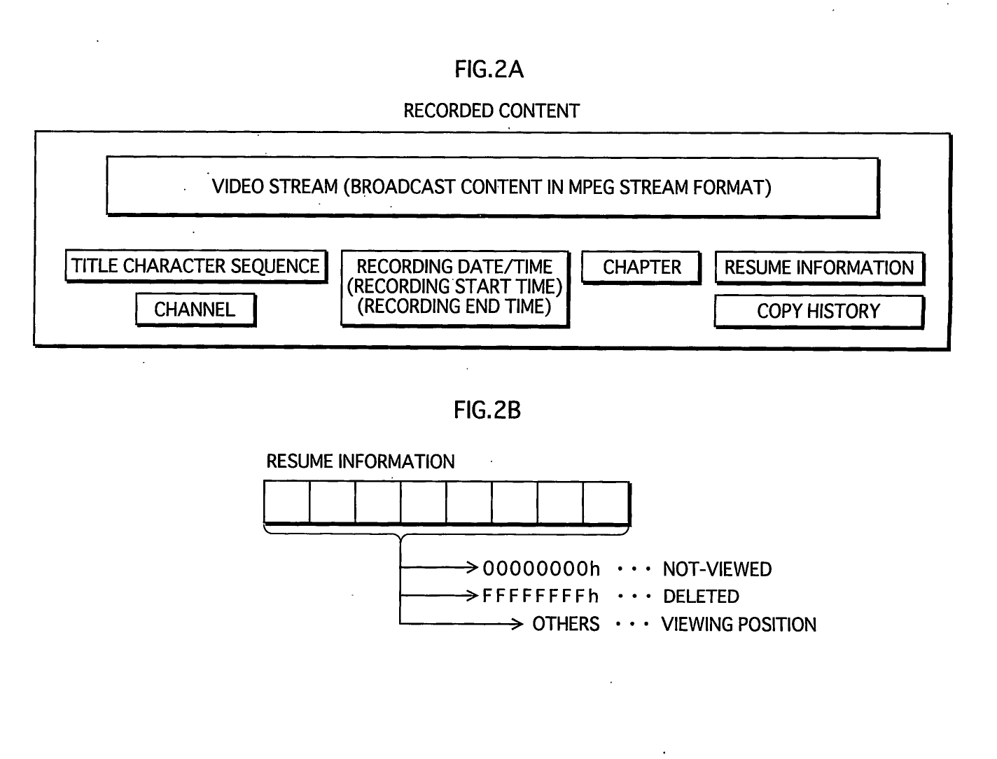

FIG. 2A shows the construction of a recorded content in the present embodiment. As shown in FIG. 2A, the recorded content includes “video stream”, “title character sequence”, “channel”, “recording date/time”, “chapter”, and “resume information”. The recorded content may also include “copy history” as the case may be.

The following describes each of the above-mentioned components of the recorded content.

The “video stream” is substantial data in the MPEG2 or MPEG4 format converted from a broadcast content.

The “title character sequence” is a text code indicating the recorded content title specified by a user.

The “channel” is information for identifying the broadcasting station that broadcast the broadcast content.

The “recording date/time” is information about the time at which the recorded content is recorded, and indicates a recording start time and a recording end time.

The “chapter” indicates an immediate reproduction position in the recorded content. A plurality of chapters can be set for each recorded content so that the user can start reproducing from any of the desired positions of the recorded content.

The “resume information” is differently treated depending on whether the recorded content is “not-viewed”, “deleted” or “viewed”. In the case of the “viewed”, the resume information indicates a position at which reproduction of the recorded content stopped the last time. FIG. 2B shows the bit assignment for the resume information. As shown in FIG. 2B, the bit assignment “00000000” (all “0”) indicates that the recorded content has not been viewed, namely, “not-viewed” (in this case, the resume information is referred to as “not-viewed information”); the bit assignment “FFFFFFFF” (all “F”) indicates that the video stream, the substantial data of the recorded content has already been deleted (in this case, the resume information is treated as “deletion information”); and any bit assignment that is neither all “0” nor all “F” indicates a position at which reproduction of the recorded content stopped the last time (in this case, the resume information is treated as “viewing position information”). The resume information is updated each time the recorded content is reproduced by the hard disk recorder 100 or the SD viewer 103, so as to indicate a position of the recorded content at which the reproduction stopped.

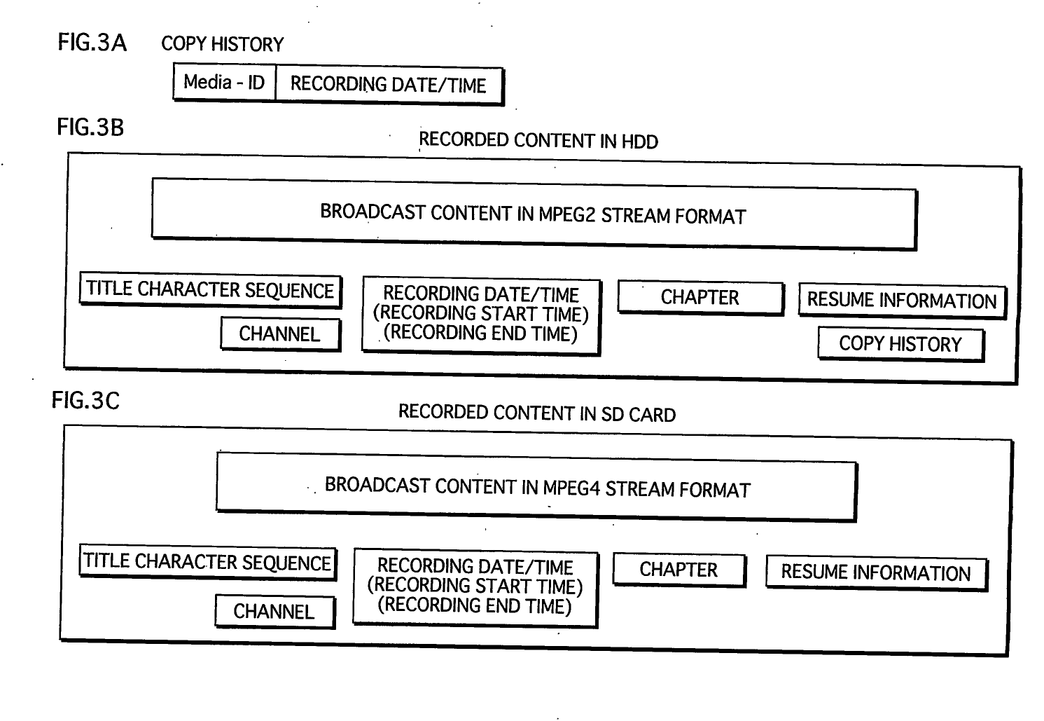

The “copy history” is information indicating a history of copying of the recorded content. When the “copy history” has identification information of the copied content and an identifier of a recording medium to which the content was copied, it indicates the fact that the recorded content was copied. FIG. 3A shows an example of the copy history. As shown in FIG. 3A, the example of the copy history uses the recording date/time as the identification information of the copied recorded content, and uses the Media-ID of the SD card 102 as the identifier of the recording medium to which the content was copied. It should be noted here that the Media-ID is an identifier (ID) of an SD card and is uniquely assigned to each SD card.

It was stated earlier that the copy history is included in the recorded content as the case may be. This means that the copy history is added to the recorded content only after the recorded content is copied, and that the copy history is not added until the recorded content is copied.

FIG. 3B shows the construction of a recorded content recorded in the hard disk. FIG. 3C shows the construction of a recorded content recorded in the SD card 102. As will be understood from comparison between FIGS. 3B and 3C, the recorded content in the hard disk has a copy history, while the recorded content in the SD card 102 does not have a copy history. This is because the recorded content in the hard disk can become a source of copying, but not the recorded content in the SD card 102.

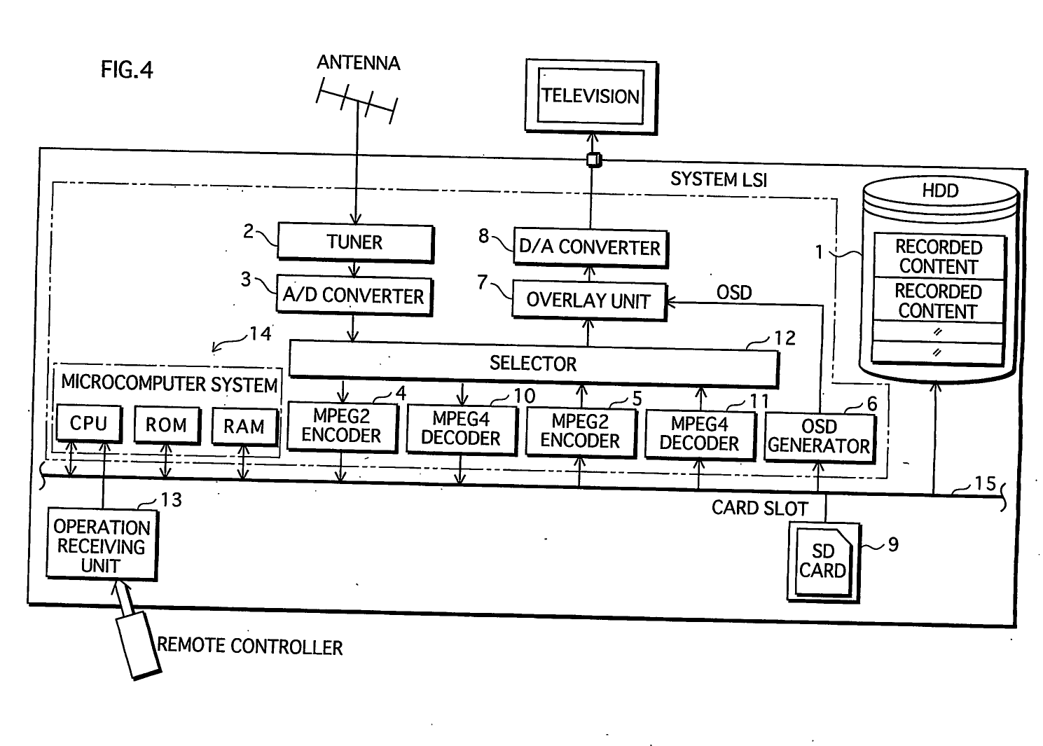

Up to now, the recorded content has been explained. Now, how the hard disk recorder 100 is manufactured will be described. The hard disk recorder 100 is mainly composed of two parts: a system LSI; and a drive apparatus. The hard disk recorder 100 is manufactured industrially by implementing these parts in/on a cabinet and a substrate. The system LSI is an integrated circuit into which various processing units for performing the functions of the hard disk recorder 100 have been integrated. FIG. 4 shows the construction of the manufactured hard disk recorder 100. As shown in FIG. 4, the hard disk recorder 100 includes a hard disk drive (HDD) 1, a tuner 2, an analog/digital (A/D) converter 3, an MPEG2 encoder 4, an MPEG2 decoder 5, an OSD generator 6, an overlay unit 7, a digital/analog (D/A) converter 8, a card slot 9, an MPEG4 encoder 10, an MPEG4 decoder 11, a selector 12, an operation receiving unit 13, and a microcomputer system 14. Of these, the MPEG2 encoder 4, MPEG2 decoder 5, OSD generator 6, card slot 9, MPEG4 encoder 10, MPEG4 decoder 11, and microcomputer system 14 are interconnected via a bus 15 in a bus-type topology (connection format).

The HDD 1 records therein a plurality of recorded contents. Areas in the HDD 1 are managed by a file system. The file system treats the video stream contained in the recorded content as a file in the file system. With such a construction, the user can delete a recorded content from the HDD 1 with ease in the same manner as in deleting a file from a personal computer.

The tuner 2 demodulates a broadcast wave, selects a broadcast station, and outputs a broadcast content in an analog broadcast signal format.

The A/D converter 3 converts the broadcast content in the analog broadcast signal format into a non-compressed (not-encoded) digital format by performing an analog-to-digital conversion.

The MPEG2 encoder 4 converts the broadcast content from the non-compressed digital format to the MPEG2 format, by encoding the broadcast content. Through the encoding, the broadcast content is converted into an MPEG2-format video stream. The video stream output from the MPEG2 encoder 4 is written into the HDD 1 together with the resume information and recording date/time, which constitute a recorded content.

The MPEG2 decoder 5 decodes (decompresses) the MPEG2-format video stream to obtain a broadcast content in a non-compressed digital format.

The OSD generator 6 generates an OSD in accordance with an instruction from the microcomputer system 14. Here, the OSD is a simple graphic design whose background, characters or the like are drawn using any of a certain number of colors (for example, 24 colors) provided in the Look Up Table (LUT) Each OSD is generated by the hard disk recorder 100 as necessary and updated in accordance with a user operation. The hard disk recorder 100 creates an OSD representing a piece of information concerning a recorded content and updates the OSD in accordance with a user operation, thus achieving an interactive operation with the user.

The overlay unit 7 overlays the broadcast content in the non-compressed digital format with an OSD, and outputs the result to the television 101. The overlay unit 7 achieves the overlay by mixing horizontal lines constituting a sheet of image with horizontal lines of an OSD. The mixture rate of the mixing can be set to obtain a desired effect of transparency of the OSD relative to the picture data of the image. For example, the mixture rate can be set so that the OSD covers the corresponding picture data portion completely, or so that the corresponding picture data portion is half-transparent.

The D/A converter 8 converts the broadcast content from a non-compressed digital format into a video signal format.

The card slot 9 is physically connected to the SD card 102 via a connector. As mentioned earlier, areas of the HDD 1 are managed by a file system. This also applies to the SD card 102. That is, areas of the SD card 102 are also managed by a file system. Accordingly, the video stream contained in a recorded content recorded in the SD card 102 can be deleted and reproduced, in the same manner as the HDD 1.

The MPEG4 encoder 10 converts the broadcast content from the non-compressed digital format to the MPEG4 format, by encoding the broadcast content. The MPEG4 encoder 10 encodes two types of broadcast contents: (1) a broadcast content in the non-compressed digital format generated by the A/D converter 3 by converting the broadcast content from the analog broadcast signal format; and (2) a broadcast content in the non-compressed digital format generated by the MPEG2 decoder 5 by decoding an MPEG2-format broadcast content stored in the HDD 1. The MPEG4 encoder 10 encodes the broadcast content of (1) above when the SD card 102 is specified as the destination to which the recorded content is to be written, and encodes the broadcast content of (2) above when the broadcast content stored in the HDD 1 is to be copied after being encoded. Broadcast contents encoded by the MPEG4 encoder 10 are written into the SD card 102 while it is inserted into the card slot 9.

The MPEG4 decoder 11, when the SD card 102 inserted in the card slot 9 contains a recorded content, decodes the MPEG4-format digital stream in the recorded content to obtain the broadcast content in the non-compressed digital format.

The selector 12, under control of the microcomputer system 14, transfers the broadcast content in the analog broadcast signal format, which has been output from the tuner 2, to both or one of the MPEG2 encoder 4 or the MPEG4 encoder 10. The selector 12 transfers both or one of the outputs from the MPEG2 decoder 5 and the MPEG4 decoder 11 to the overlay unit 7.

The operation receiving unit 13 receives user operations performed by the user on a remote controller or the front panel of the hard disk recorder 100.

The microcomputer system 14 is a typical computer system including a CPU, a ROM having a program therein, and a RAM. Computation or processing of information for desired purposes is performed when the program stored in the ROM is read by the CPU and the program cooperates with the hardware resources. The above-mentioned purposes include recording, reproducing, copying, deleting, and interactive operations. When a specific means achieved by the cooperation between the program and the hardware resources (the HDD 1 to the selector 12) performs computation or processing for a specific purpose, an information processing apparatus (hard-disk recorder 100) dedicated to the specific purpose is constructed.

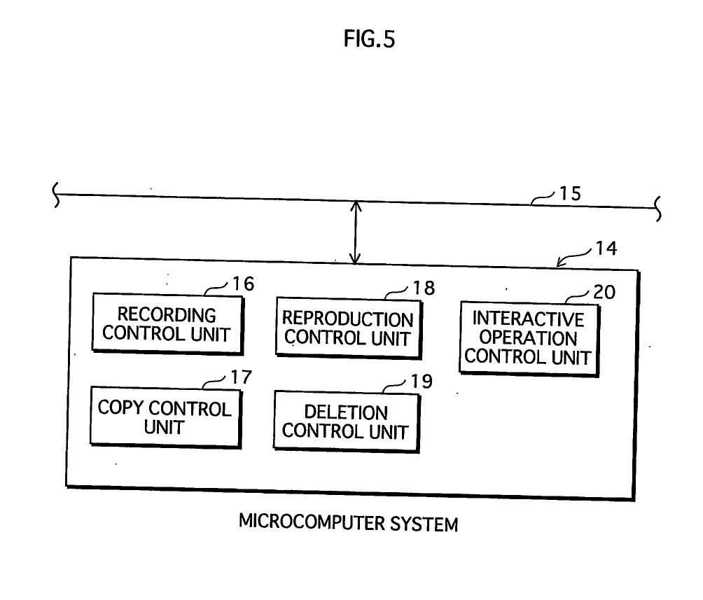

FIG. 5 is a functional diagram of the specific means achieved by the cooperation between the program and the hardware resources. As shown in FIG. 5, the microcomputer system 14 includes a recording control unit 16, a copy control unit 17, a reproduction control unit 18, a deletion control unit 19, and an interactive operation control unit 20.

The recording control unit 16 controls the recording process of the hard disk recorder 100. More specifically, the recording control unit 16 controls the recording process by instructing the tuner 2 to receive the broadcast content in the analog broadcast signal format, instructing the A/D converter 2 to convert the received broadcast content into the non-compressed digital format, and instructing the MPEG2 encoder 4 to encode the broadcast content and convert it from the non-compressed digital format to the MPEG2 format.

The copy control unit 17 controls the copy process of the hard disk recorder 100. The copy process performed by the copy control unit 17 is characterized by instructing the MPEG2 decoder 5 to decode a recorded content in the MPEG2 format stored in the HDD 1 into the non-compressed digital format, and instructing the MPEG4 encoder 10 to convert the recorded content from the non-compressed digital format to the MPEG4 format and write it into the SD card 102. This process includes a format conversion from MPEG2 to MPEG4, which reduces the size of the recorded content and enables the small-size recorded content to be written into the SD card 102.

The reproduction control unit 18 controls the reproduction of the hard disk recorder 100. The control by the reproduction control unit 18 is characterized by the update of the resume information. The reproduction control unit 18, each time the MPEG decoder 5 starts and stops a reproduction, updates the resume information to indicate a position at which the reproduction stopped. In addition to the update, the reproduction control unit 18 updates the resume information to synchronize the resume position (the position at which the reproduction of the recorded content stopped the last time) between the HDD 1 and the SD card 102, in terms of recorded content shaving the sameness. This function achieves a “relay viewing” by which the user can resume viewing on a different reproduction apparatus. With the relay viewing, for example, even if the user stops viewing a recorded content at some midpoint while viewing it on the hard disk recorder 100, the user can resume viewing on the SD viewer 103 from the midpoint.

The deletion control unit 19 controls the deletion process of the hard disk recorder 100. The deletion process controlled by the deletion control unit 19 is characterized in that the deletion is performed in two steps. In the first deletion step, the video stream in a recorded content is deleted, and the resume information is set to “FFFFFFFF” (all “F”) to indicate that the video stream has been deleted. By deleting the video stream, which occupies a largest proportion of a recorded content in size, a large amount of free space is secured in the HDD 1 or the SD card 102. On the other hand, the recording date/time and the resume information are left in the HDD 1 or the SD card 102. This is done for the purpose of leaving information that indicates that the video stream of the recorded content was deleted. With this arrangement, it is possible to delete the recorded contents having the sameness from both the HDD 1 and the SD card 102 all at once in synchronization, in which the recording date/time and the resume information left in one of the HDD 1 and the SD card 102 are used to delete a corresponding recorded content from the other recording medium.

In the second deletion step, the recorded contents having the sameness, including the recording date/time and the resume information, are deleted from both the HDD 1 and the SD card 102 all at once in synchronization. This secures a large amount of free space in the HDD 1 and the SD card 102.

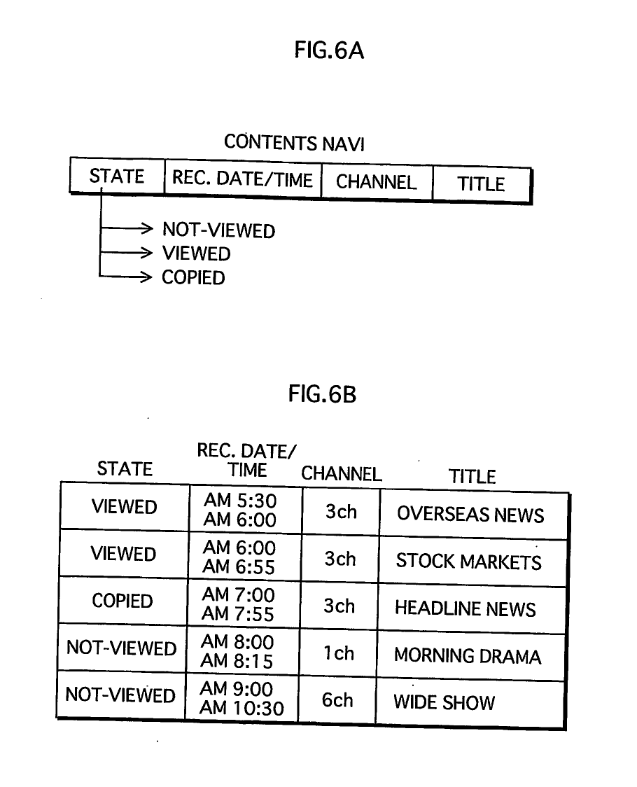

The interactive operation control unit 20 controls the interactive operation of the hard disk recorder 100. The interactive operation control unit 20 controls the interactive operation by instructing the OSD generator 6 to generate an OSD called “contents navi”, and instructing the overlay unit 7 to overlay the broadcast content with the contents navi. The contents navi is a GUI (Graphical User Interface) part that represents a recorded content graphically. FIG. 6A shows the format of the contents navi. As shown in FIG. 6A, the contents navi includes a state column, a recording date/time column, a channel column, and a title column. Of these, the recording date/time column, channel column, and title column indicate recording dates/times, channels, and titles of recorded contents, respectively. The state column indicates whether a recorded content has not been viewed (“not-viewed”), has been viewed (“viewed”), or has been copied (“copied”) for each recorded content, based on the resume information and the copy history. Since the contents navi is a GUI part, the state of the contents navi changes depending on the user operation the operation receiving unit 13 receives. Accordingly, each entry of the contents navi, which corresponds to a recorded content, is in either the normal state or the focus state. When an entry is in the normal state, the entry is not a target of a user operation. When an entry is in the focus state, the entry is being selected as a target of a user operation, which can be specified by the user by operating arrow keys on the remote controller. Such an arrangement of changing the state of each entry of the contents navi in accordance with the user operation on the remote controller provides the user with a GUI environment composed of the OSD and the remote controller. FIG. 6B shows a specific example of the contents navi. In FIG. 6B, the contents navi includes entries corresponding to recorded contents with titles “Overseas News”, “Stock Markets”, “Headline News”, “Morning Drama”, and “Wide Show”. The state column of the contents navi indicates that “Overseas News” and “Stock Markets” have been viewed, that “Headline News” has been copied, and that “Morning Drama” and “Wide Show” have not been viewed.

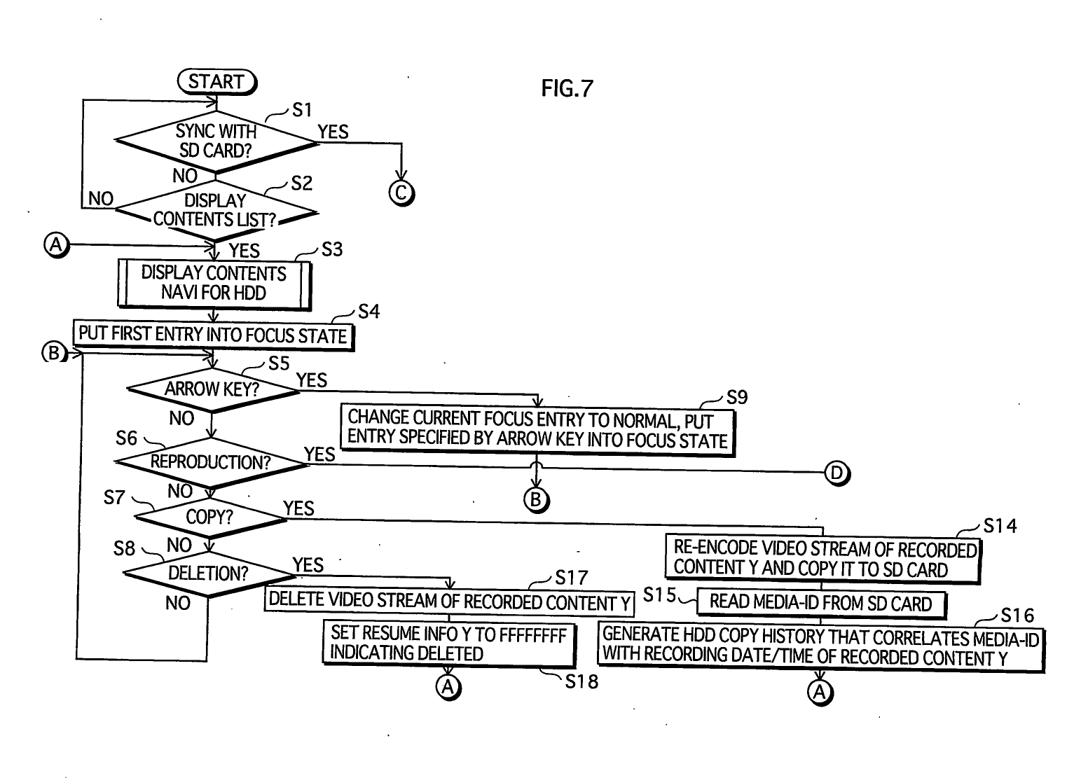

Of the above-described processes controlled by the microcomputer system 14, the copy, reproduction, and deletion processes are mainly achieved by the program stored in the ROM of the microcomputer system 14. FIGS. 7-10 are flowcharts showing processing procedures of the program. The following describes the processing procedures for the copy, reproduction, and deletion processes of the microcomputer system 14, with reference to the flowcharts.

Steps S1-S2 constitute a main routine of the flowcharts. In step S1, the user determines whether to select a sync of the resume information between the HDD 1 and the SD card 102 (step S1 in FIG. 7). In the following step S2, the user determines whether to display a list of recorded contents that are stored in the HDD 1 (step S2).

If the user selects to display a list of recorded contents, a contents navi showing information of recorded contents that are recorded in the HDD 1 is displayed (step S3). The first entry of the contents navi is put into the focus state (step S4). The succeeding steps S5-S8 constitute an event-waiting loop.

When an arrow key is depressed (“YES” in step S5), the entry that is currently in the focus state is changed to the normal state, and an entry specified by the arrow key is put into the focus state (step S9). The control then returns to step S5. The operation in these steps enables an entry of the contents navi in the focus state to change as the user depresses an arrow key. Hereinafter, a recorded content corresponding to the entry in the focus state and being a processing target is referred to as a “recorded content y”.

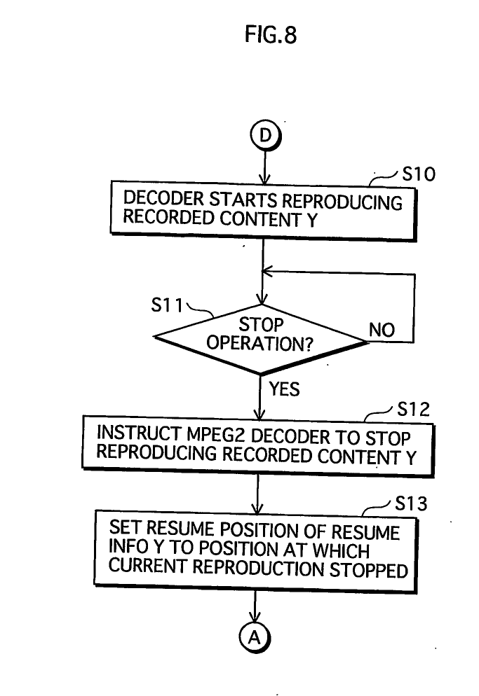

When a reproduction operation is selected (“YES” in step S6), the MPEG2 decoder 5 is instructed to start reproducing the recorded content y (step S10 in FIG. 8). After this, if a stop operation is selected (“YES” in step S11), the MPEG2 decoder 5 is instructed to stop reproducing the recorded content y (step S12). A position at which the reproduction stopped is set in the resume information y, which corresponds to the recorded content y, as a resume position (step S13). The control then returns to the event-waiting loop composed of steps S5-S8.

When a copy operation is selected (“YES” in step S7), the video stream of the recorded content y is re-encoded and then copied to the SD card 102 (step S14). The Media-ID is read from the SD card 102 (step S15). A copy history that correlates the read Media-ID with the recording date/time of the recorded content y is generated and stored in the HDD 1 (step S16). The control then returns to the event-waiting loop composed of steps S5-S8.

When a delete operation is selected (“YES” in step S8), the video stream of the recorded content y is deleted (step S17). The resume information y is set to “FFFFFFFF” (all “F”) to indicate that the video stream has been deleted (step S18). The control then returns to the event-waiting loop composed of steps S5-S8.

The list of recorded contents, which are recorded in the HDD 1, is updated and displayed (step S3) each time a recorded content is reproduced, copied, or deleted. That is say, each time such an operation is performed, the latest state of the recorded contents is displayed.

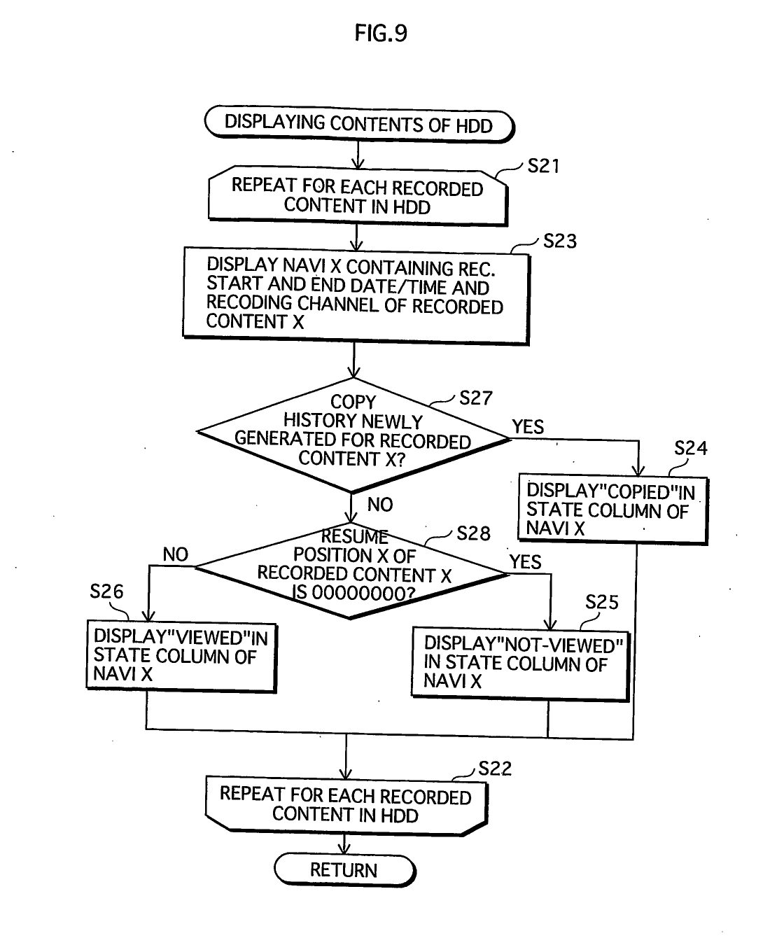

FIG. 9 is a flowchart showing a detailed procedure of step S3 that can be written in a computer description language as a subroutine for executing the display of a list of contents recorded in the HDD 1.

The flowchart of FIG. 9 is constructed as a loop that repeats steps S23-S28 for each content recorded in the HDD 1 (steps S21 and S22). In this loop structure, a processing-target recorded content is referred to as a “recorded content x”. In steps S23-S28, a recording start date/time, a recording end date/time, and a recording channel of the recorded content x are displayed in a contents navi x, which corresponds to the recorded content x (step S23), and the state column of the contents navi x is updated (step S24, S25, S26).

The state column of the contents navi x is updated in one of step S24, S25 and S26. Steps S27 and S28 are executed to determined the step (step S24, S25 or S26) in which the state column of the contents navi x is updated. If it is judged in step S27 that a copy history was newly generated for the recorded content x (“YES” in step S27), the state column of the contents navi x shows “copied”.

If it is judged in step S27 that a copy history has not been generated for the recorded content x (“NO” in step S27), and if it is judged in step S28 that the resume information x, which corresponds to the recorded content x, is set to “00000000” (all “0”) (“YES” in step S28), the state column of the contents navi x shows “not-Viewed” (step S25).

If it is judged in step S27 that a copy history has not been generated for the recorded content x (“NO” in step S27), and if it is judged in step S28 that the resume information x is not set to “00000000” (“NO” in step S28), the state column of the contents navi x shows “viewed” (step S26).

If a recorded content is reproduced (steps S10-S12), and the resume information is updated (step S13), the control returns to step S3 and the state column of the contents navi is updated from “not-viewed” to “viewed” (step S26). If a recorded content is copied (steps S14-S15), and a copy history is newly generated (step S16), the control returns to step S3 and the state column of the contents navi is updated from “viewed” to “copied” (step S24).

As described above, the state column of the contents navi is updated to reflect a copy or reproduction operation. This enables the user to recognize, at a glance, which contents have been viewed, have not been viewed, or have been copied.

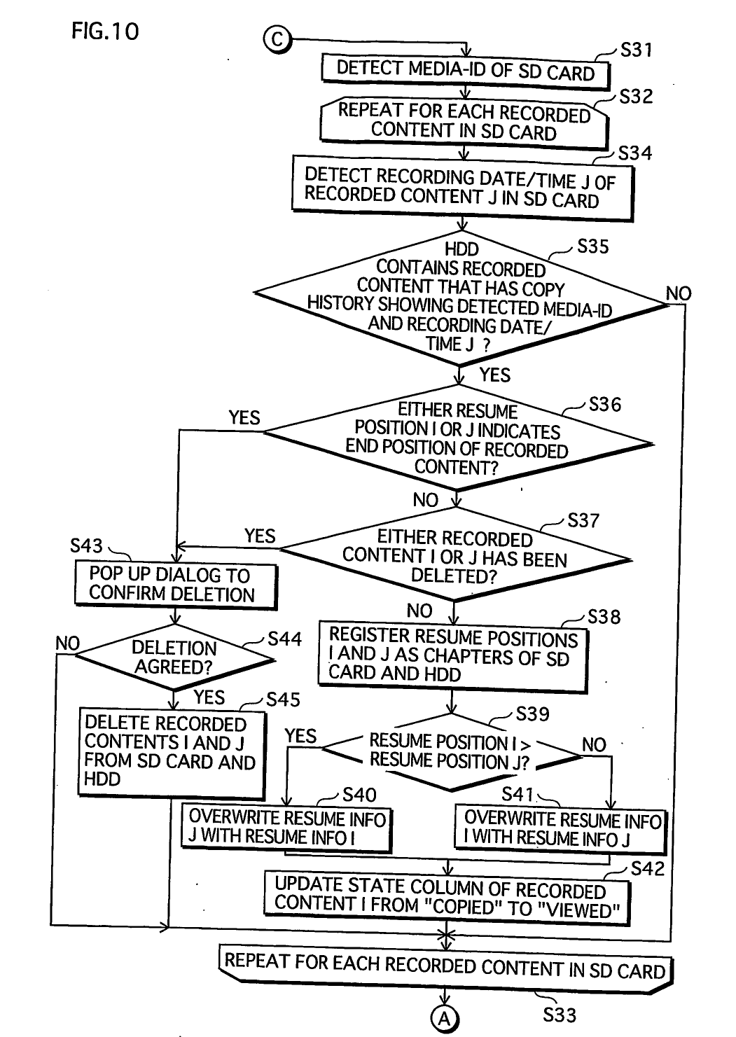

If the user selects, in step S1, a sync of the resume information between the HDD 1 and the SD card 102, the resume information sync process is executed. FIG. 10 is a flowchart showing the procedure of the resume information sync process. The following describes the resume information sync process with reference to FIG. 10. After the Media-ID of the SD card 102 is detected (step S31), the process enters a loop composed of steps S32-S33. In this loop, steps S34-S42 are repeated for each content recorded in the SD card 102.

In the following description, a content that is recorded in the SD card 102 and is the target of the process is referred to as “recorded content j”, and a content that is recorded in the HDD 1 and corresponds to the recorded content j is referred to as “recorded content i”. The recorded content i is a recorded content that is stored in the HDD 1 and has certain sameness as the recorded content j. More specifically, the recorded content i is determined as follows through steps S34 and S35. First, a recording date/time j, at which the recorded content j was recorded in the SD card 102, is detected (step S34). It is then judged whether the HDD 1 contains a recorded content that has a copy history showing the detected Media-ID and the recording date/time j (step S35). A content that is recorded in the HDD 1 and satisfies the condition of step S35 is determined as the recorded content i.

It should be noted here that in the present example, a content that is recorded in the HDD 1 and has a copy history showing the Media-ID and the recording date/time of the recorded content j is determined as the recorded content i. However, in addition, it may be judged whether the content that is recorded in the HDD 1 was broadcast on the same channel as the recorded content j. By adding the judgment, even if the HDD 1 contains a plurality of recorded contents that were broadcast over the same time period as the recorded content j, the recorded content i can be identified in a more reliable manner.

After the recorded content i is determined, judgment steps S36 and S37 are executed, and then the resume position i of the recorded content i and the resume position j of the recorded content j are registered as chapters of the HDD 1 and the SD card 102 (step S38). The resume information sync is performed in steps S39-S41.

As described above, the resume positions i and j of the recorded contents i and j are registered as chapters of the HDD 1 and the SD card 102 in step S38. This enables the user to reproduce the recorded content from any desired resume position in the HDD 1 or the SD card 102 by selecting a chapter jump operation.

The following describes, in detail, the resume information sync process performed in steps S39-S41. First, it is judged whether the resume position i is after the resume position j, that is to say, whether the resume position i> the resume position j (step S39). If it judged positively in step S39, the resume information j is overwritten with the resume information i (step S40). If it judged negatively in step S39, the resume information i is overwritten with the resume information j (step S41). The state column of the contents navi for the recorded content i is updated from “copied” to “viewed” (step S42).

Steps S36 and S37 are executed to judge whether exceptional processes should be executed. In step S36, it is judged whether either the resume position i or the resume position j indicates the end position of the recorded content (step S36). If it is judged positively in step S36, it is judged whether either the recorded content i or the recorded content j has been deleted (step S37). If it is judged positively in step S36, a dialog is popped up to confirm a deletion (step S43). If the user agrees to the deletion (“YES” in step S44), both the recorded content i and the recorded content j are deleted from the HDD 1 and the SD card 102 (step S45). Such a deletion is performed to prevent transient broadcast contents from occupying the HDD1 and the SD card 102. It should be noted here that the transient broadcast contents refer to broadcast contents such as news or variety show programs that are apt to be viewed only once. If the transient broadcast contents, which are broadcast constantly, for example, on a daily or weekly basis, are recorded as requested, the available storage space of the HDD 1 or the SD card 1 will be completely consumed soon. To prevent such capacity shortage of the recording mediums, the hard disk recorder 100 of the present embodiment asks the user, when the resume information for either the HDD 1 or the SD card 102 indicates the end of a broadcast content, whether to agree to the deletion of the broadcast content from both the HDD 1 and the SD card 102, and deletes it by consent of the user. Such a sync deletion of recorded content from both the HDD 1 and the SD card 102 prevents the recording mediums from being occupied by the transient broadcast contents.

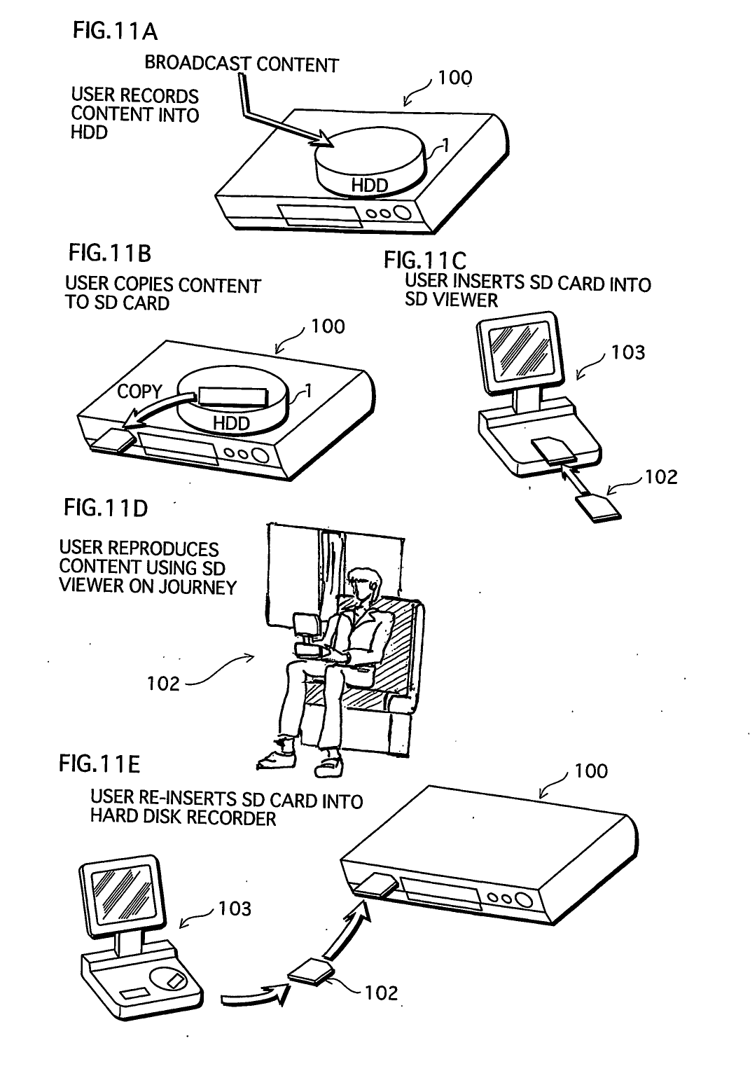

Now, an example of operation of the hard disk recorder 100 will be described with reference to FIGS. 11A-13. FIGS. 11A-11E show how the HDD 1, SD car 102, and SD viewer 103 are used by the user. A broadcast content is recorded into the HDD 1 of the hard disk recorder 100 (FIG. 11A). A recorded content containing the broadcast content is copied from the HDD 1 to the SD card 102 (FIG. 11B).

The SD card 102 storing the recorded content is inserted into the SD viewer 103 (FIG. 11C). The user goes out with the SD viewer 103. The user reproduces the recorded content using the SD viewer 103 on his/her journey (FIG. 1D). After his/her return to home, the user removes the SD card 102 from the SD viewer 103 and re-connects it to the hard disk recorder 100 (FIG. 11E).

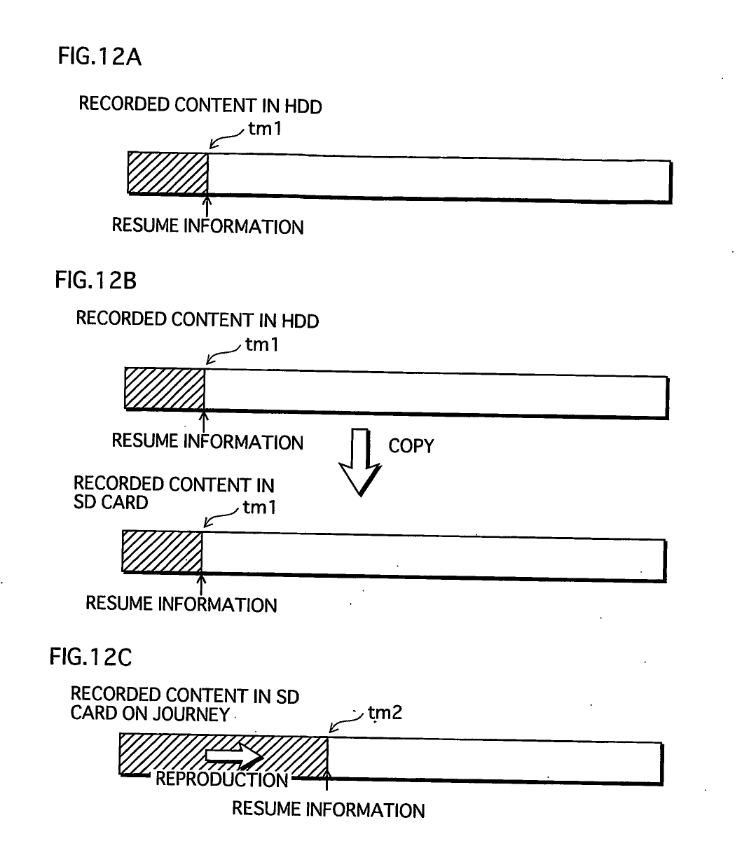

FIG. 12A shows the state of the HDD 1, in the present example, after the broadcast content is recorded therein to be a part of the recorded content and then the recorded content is reproduced and viewed by the user up to a position represented by time tm1. FIG. 12A also shows that the resume information indicates the position tm1 at which the reproduction stopped.

FIG. 12B shows the state of the HDD 1 and the SD card 102 after the recorded content is copied from the HDD 1 to the SD card 102. As shown in FIG. 12B, after the copying, the SD card 102 also stores the recorded content therein, and the resume information for the SD card 102 also indicates the position tm1 at which the reproduction stopped.

FIG. 12C shows the state of the SD card 102 after the user reproduces the recorded content using the SD viewer 103 on his/her journey. As shown in FIG. 12C, after the reproduction, the resume information for the SD card 102 indicates time tm2 as a position at which the reproduction stopped.

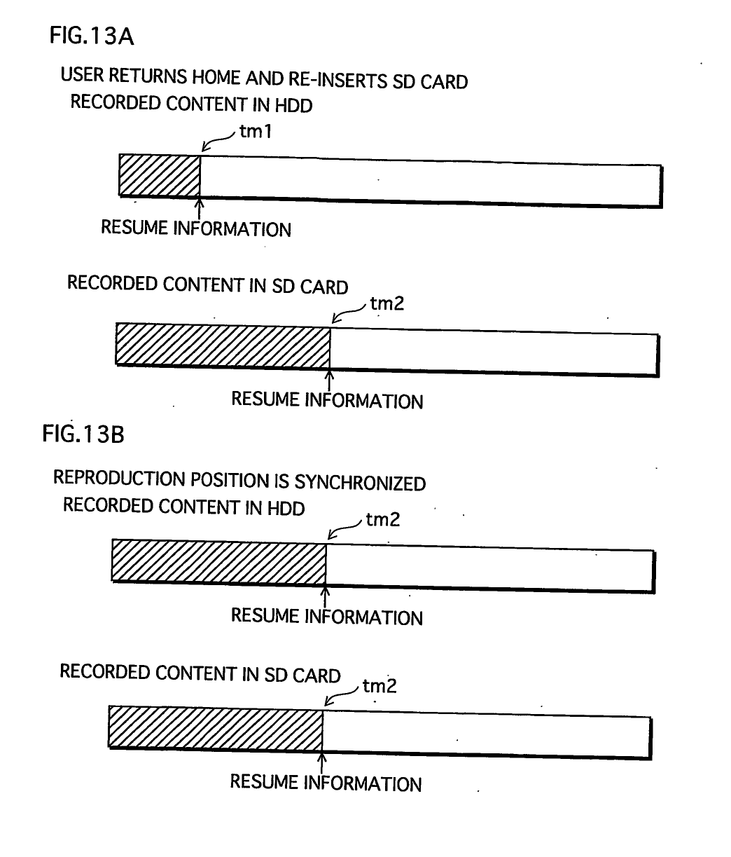

FIG. 13A shows the state of the HDD 1 and the SD card 102 after the user returns to his/her home and re-connects the SD card 102 to the hard disk recorder 100. As understood from FIG. 13A, the resume information for the HDD 1 still indicates tm1 and does not match the resume information for the SD card 102 which indicates tm2.

Suppose that at this point in time, the user instructs to execute the sync operation to synchronize the resume information between the HDD 1 and the SD card 102.

FIG. 13B shows the state of the HDD 1 and the SD card 102 after the execution of the sync operation. As shown in FIG. 13B, the resume information for both the HDD 1 and the SD card 102 indicates tm2. Such an arrangement prevents the user from viewing a portion of the recorded content that the user once viewed.

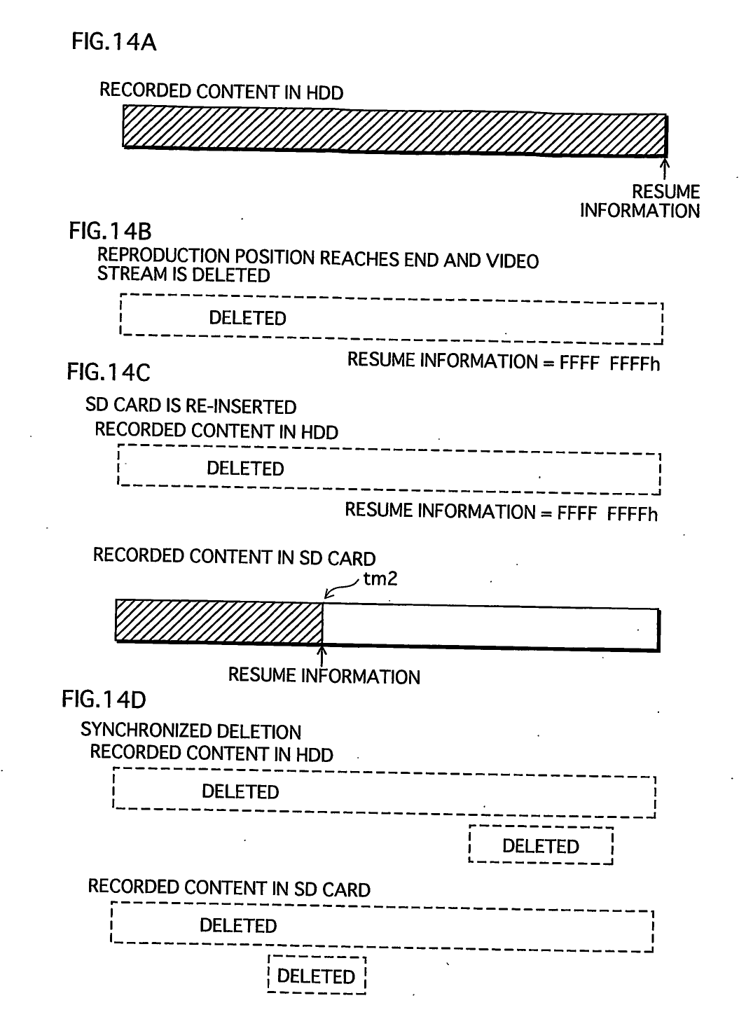

FIG. 14A shows the state of the content recorded in the HDD 1 after the recorded content is further reproduced to the end thereof. As shown in FIG. 14A, the resume information indicates the end of the recorded content. It is supposed here that the user, having viewed the recorded content, deletes the recorded content. FIG. 14B shows the state of the content recorded in the HDD 1 after the recorded content is deleted. As shown in FIG. 14B, the video stream constituting the main portion of the recorded content is deleted as indicated by the dotted line, and the resume information is set to “FFFFFFFF” (all “F”) to indicates that the video stream has been deleted. FIG. 14C shows the state of the HDD 1 and the SD card 102 after the execution of the deletion.

Suppose here that at this point in time, the user instructs to execute the sync operation to synchronize the viewing position between the HDD 1 and the SD card 102. FIG. 14D shows the state of the HDD 1 and the SD card 102 after the execution of the sync operation. As shown in FIG. 14D, the recorded content including the resume information as well as the video stream is completely deleted from both the HDD 1 and the SD card 102. This secures a large amount of free space in the HDD 1 and the SD card 102.

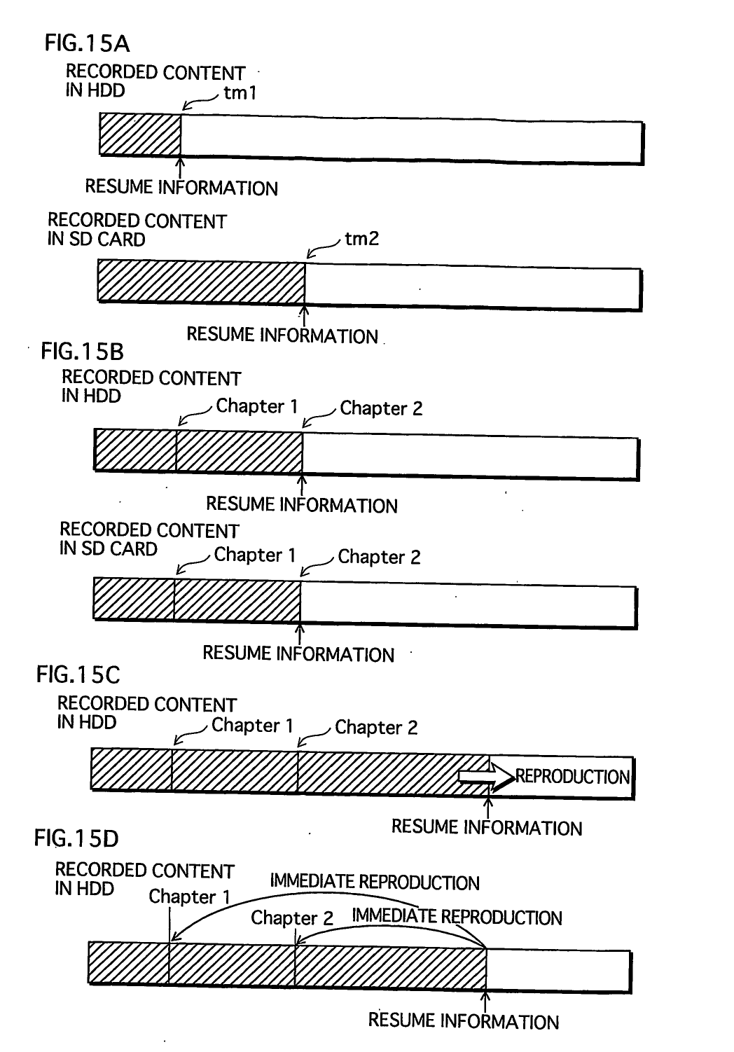

When the sync operation of the resume information is executed, the resume information indicating the resume positions in the HDD 1 and the SD card 102 are registered as chapters in these recording mediums. FIGS. 15A-15D show an example of the process in which chapters are registered and used. FIG. 15A shows the state of the HDD 1 and the SD card 102 before the sync operation is executed to synchronize the viewing position, where the resume information for the HDD 1 indicates tm1, and the resume information for the SD card 102 indicates tm2. FIG. 15B shows the state of the HDD 1and the SD card 102 after the execution of the sync operation. As shown in FIG. 15B, the resume positions tm1 and tm2 are respectively registered as chapters 1 and 2 with each of the HDD 1 and the SD card 102. FIG. 15C shows the state of the HDD 1 when the recorded content therein is further reproduced. Since, as shown in FIG. 15C, chapters 1 and 2 have been registered, the user can return to any of the viewing positions (tm1, tm2) represented by the chapters 1 and 2 from the currently viewing position, by executing the chapter jump operation. FIG. 15D shows that the user can reproduce the recorded content from any desired resume position (chapter 1 or 2) in the HDD 1 or the SD card 102 by selecting a chapter jump operation.

As described above, according to the present embodiment, the resume information is updated to synchronize the resume position between the HDD 1 and the SD card 102, in terms of contents that are respectively recorded in the HDD 1 and the SD card 102 through copying and have the sameness. This enables the user to prevent from viewing a portion of the recorded content that the user once viewed, regardless of which recorded content in the HDD 1 or the SD card 102 has been viewed more than the other.

In the present embodiment, the SD card 102 and the hard disk recorder 100 are physically connected to each other via the card slot 9. However, they may be connected to each other logically via network. The logical connection between the SD card 102 and the hard disk recorder 100 can be achieved, for example, as follows. First, the SD viewer 103 is linked to the hard disk recorder 100 by wired connection via the USB or IEEE1394 interface. The SD viewer 103 then transmits the resume information, which corresponds to the content recorded in the SD card 102, to the hard disk recorder 100 on the USB or IEEE1394 interface. The hard disk recorder 100 updates the resume information for both the SD card 102 and the HDD 1 to synchronize the resume information between the SD card 102 and the HDD 1.

Alternatively, the SD viewer 103 and the hard disk recorder 100 may perform a communication on a network to establish a link or a connection between them. In this case, the SD viewer 103 transmits the resume information, which corresponds to the content recorded in the SD card 102, to the hard disk recorder 100 on the establish link or connection, and the hard disk recorder 100 updates the resume information for both the SD card 102 and the HDD 1 to synchronize the resume information between the SD card 102 and the HDD 1. With such an arrangement, the synchronization of the resume information between the hard disk recorder 100 and the SD card 102 is possible even if the hard disk recorder 100 is not physically connected to the SD card 102.

In the present embodiment, it is the hard disk recorder 100 that receives and records therein a broadcast content. However, the SD viewer 103 may receive and record a broadcast content.

In the present embodiment, the reproduction resume position indicated by the resume information is represented by time information, as it is desirable. However, to be compatible with the DVD-Video standard in which a reproduction position is represented by logical addresses in a recording medium, it is desirable that the reproduction apparatus has a function to switch between the time information and the logical addresses.

It should be noted here that a content may be stored in the SD card 102 in any appropriate format, such as the ASF format. Here, if the adopted format represents the reproduction positions by direct addresses in a recording medium, it is desirable that the reproduction apparatus has a function to switch between the time information and the direct addresses.

### Embodiment 2

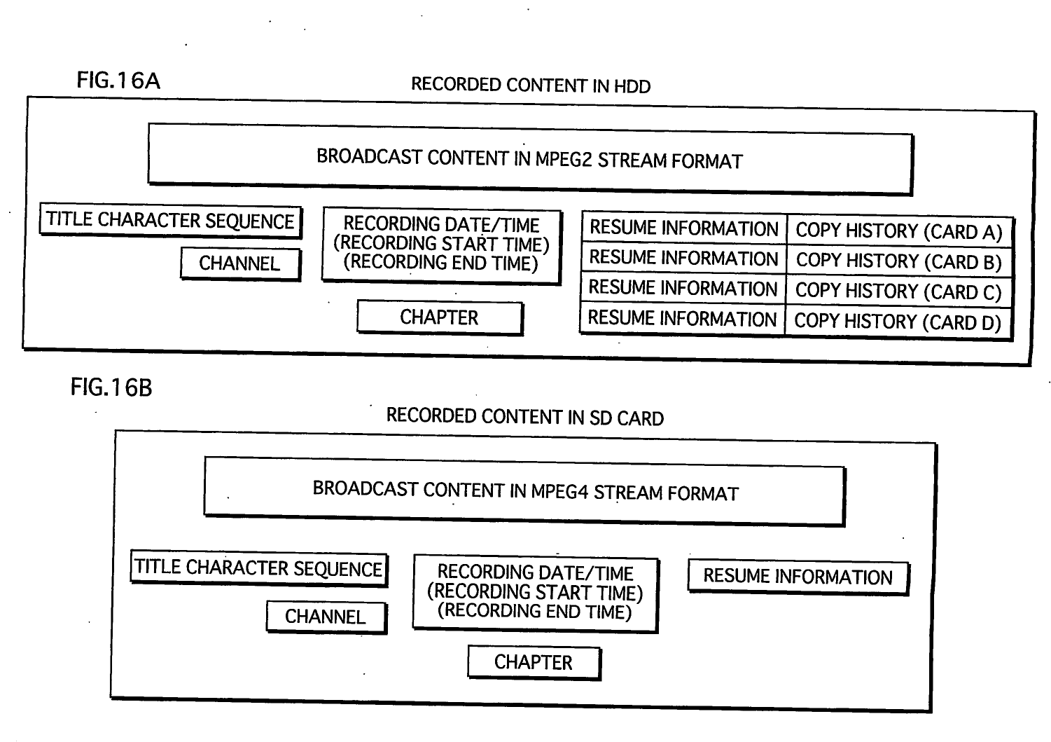

In Embodiment 2, the hard disk recorder 100 provides a multiuser support. FIG. 16A shows the construction of a content recorded in the HDD 1 in Embodiment 2, for achiving the multiuser support. The recorded content shown in FIG. 16A differs from that of FIG. 2A in that it has a plurality of sets of resume information and a copy history, which are respectively assigned to a plurality of users (A, B, C, and D), respectively. The Media-ID in each copy history indicates the Media-ID of an SD memory card (card A, B, C, or D) owned by a user.

FIG. 16B shows the construction of a content recorded in the SD card in Embodiment 2. The recorded content in the SD card, which is different from the recorded content of the HDD 1 in that it has only one set of resume information and a copy history, has the same construction as the recorded content in Embodiment 1.

With the above-mentioned construction in which each recorded content stored in the HDD 1 includes a plurality of copy histories that respectively correspond to a plurality of SD cards owned by a plurality of users, the synchronization of the resume information can be performed for each user, namely for each SD card owned by each user. That is to say, for example, when the synchronization of the resume information between the HDD 1 and the SD card owned by user A is to be performed, first it is judged whether the HDD 1 contains a copy history that has the same Media-ID as that of the SD card owned by user A, and if the judgment result is in the positive, the resume information is synchronized between the HDD 1 and the SD card owned by user A that has been judged to have the same Media-ID as the copy history of the HDD 1. In such a manner, the synchronization of the resume information is performed for each user.

As explained above, the present embodiment, in which each recorded content has a plurality of sets of resume information and a copy history, provides a multiuser support. This enables the recorded contents to be used efficiently.

### Embodiment 3

Embodiment 3, which is a modification of Embodiment 2, enables a content to be automatically copied from the HDD 1 to the SD card 102 when the SD card 102 is inserted into the hard disk recorder 100.

When the user programs the hard disk recorder 100 to record a broadcast content in advance, the microcomputer system 14 receives from the user the Media-ID of an SD card to which, the user desires, the recorded broadcast content is copied in future. When recording the specified broadcast content by the programmed recording, the hard disk recorder 100 writes the received Media-ID, as an information element, into the recorded content in the HDD 1 that contains the specified broadcast content. With this arrangement, when, later, an SD card having the Media-ID is inserted into the hard disk recorder 100, the hard disk recorder 100 automatically copies the recorded content to the inserted SD card.

The above-explained automatic copying improves the convenience of the user since it eliminates the need for instructing the copying after the execution of the programmed recording.

### Embodiment 4

In Embodiment 4, each recorded content recorded in the HDD 1 and the SD card 102 includes a distributed content, while in Embodiment 1, each recorded content recorded in the HDD 1 and the SD card 102 includes a broadcast content. The distributed contents refer to contents distributed by a distribution server existing on a network. The distributed contents differ from the broadcast contents in that they are distributed on demand. The hard disk recorder 100 and the SD viewer 103 in Embodiment 4 access the distribution server via the network, download a distributed content from the distribution server, and record the downloaded distributed content. It is preferable that the distributed contents to be downloaded are in the MPEG4 format. The hard disk recorder 100 and the SD viewer 103 record the downloaded distributed contents into the HDD 1 and the SD card 102, respectively. As is the case with Embodiment 1, the hard disk recorder 100 can update the resume information to synchronize the resume position between the HDD 1 and the SD card 102 after, for example, distributed contents recorded in the HDD 1 and the SD card 102 are reproduced and the SD card 102 is re-inserted into the hard disk recorder 100.

As described above, according to the present embodiment, as is the case with Embodiment 1, it is possible to synchronize the resume (viewing) position between the HDD 1 and the SD card 102 even if both the hard disk recorder 100 and the SD viewer 103 download and record distributed contents into the HDD 1 and the SD card 102, respectively.

### Embodiment 5

Embodiment 5 is characterized by achieving the synchronization of the viewing “period” between different recording mediums, while Embodiment 1 discloses how to achieve the synchronization of the viewing position which is regarded as a “point”.

The period synchronized in Embodiment 5 is a period of substantial viewing. That is to say, the target of synchronization is a time period during which a content is reproduced at a normal speed, excluding periods during which a content is fast-forwarded, for example, at a double speed.

In Embodiment 5, to achieve the synchronization of the viewing periods, the hard disk recorder 100 creates reproduction history information with the following procedure.

In Embodiment 5, when a normal reproduction is switched to a fast-forward during a reproduction of a video content, the start position of the fast-forward is regarded as a reproduction stop position. Also, when a fast-forward is switched back to a normal reproduction, the start position of the normal reproduction is regarded as a reproduction start position. With this arrangement, periods during which the content was fast-forwarded are not regarded as reproduction periods, and only periods during which normal reproduction was performed are recorded, as the reproduction periods, in the reproduction history information.

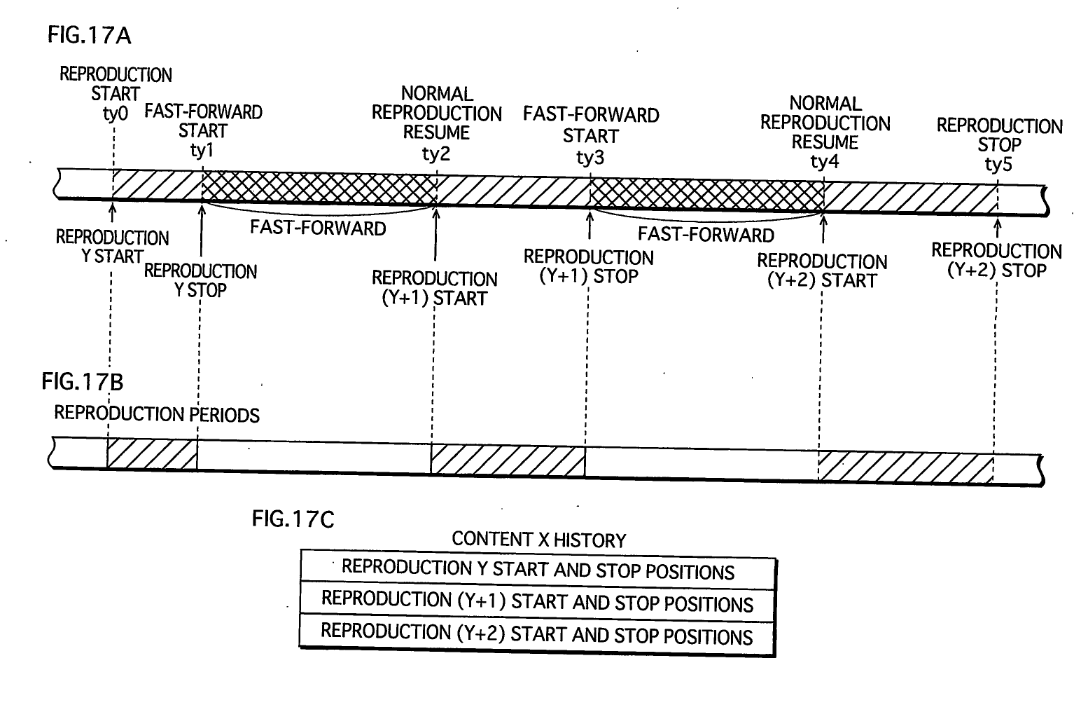

FIGS. 17A-17C show how the reproduction history information is created, where a reproduction stop position is a position at which a normal reproduction is switched to a fast-forward, and a reproduction start position is a position at which a fast-forward is switched to a normal reproduction.

FIG. 17A shows an example case in which a fast-forward start operation, a normal reproduction resume operation, a fast-forward start operation, and a normal reproduction resume operation are performed in the stated order respectively at positions ty1, ty2, ty3, and ty3 during a period between a reproduction start operation and a reproduction stop operation that are performed respectively at positions ty0 and ty5. It is supposed here that the position ty1 for a fast-forward start operation is regarded as a position at which y^{th} reproduction stops, that the position ty2 for a normal reproduction resume operation is regarded as a position at which (y+1)^{th} reproduction starts, that the position ty3 for a fast-forward start operation is regarded as a position at which (y+1)^{th} reproduction stops, and that the position ty4 for a normal reproduction resume operation is regarded as a position at which (y+2)^{th} reproduction starts. It is also supposed here that the reproduction of the video content x stops when the (y+2)^{th} reproduction stops.

FIG. 17B shows the reproduction periods that are obtained from the normal reproductions and fast-forwarding shown in FIG. 17A. FIG. 17C shows the reproduction history information created in correspondence with the reproduction shown in FIGS. 17A and 17B.

The reproduction history information created as described above, which shows only the periods during which a normal reproduction was performed, excluding the periods during which the content was fast-forwarded, is used as the resume information. With this construction, even if the user has viewed a video content skipping some parts, the parts the user has substantially viewed are indicated in detail.

The synchronization of period between the HDD 1 and the SD card 102 is achieved by implementing the logical addition (OR) operation of the reproduction periods in the HDD 1 and the SD card 102, and updates the resume information to indicate that both the HDD 1 and the SD card 102 have the same reproduction periods that are the result of the logical OR operation.

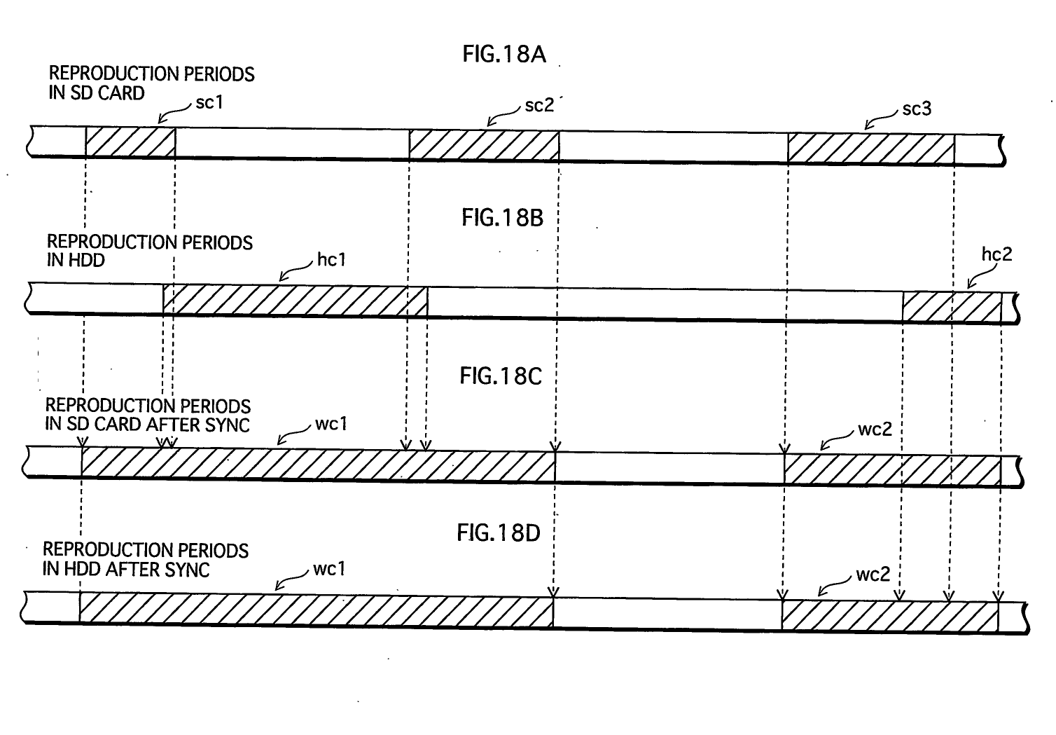

FIGS. 18A-18D shows how the reproduction periods are synchronized between the HDD 1 and the SD card 102. It is supposed here that the reproduction periods in the SD card correspond to those shown in FIG. 17B. FIGS. 18A and 18B shows the state of the HDD 1 and the SD card 102 before the synchronization is performed. As shown in FIG. 18A, the SD card 102 has reproduction periods sc1, sc2, and sc3. As shown in FIG. 18B, the HDD 1 has reproduction periods hc1 and hc2. FIGS. 18C and 18D shows the state of the HDD 1 and the SD card 102 after the synchronization is performed. As shown in FIGS. 18C and 18D, both the HDD 1 and the SD card 102 have the same reproduction periods wc1 and wc2, which are results of combining the reproduction periods of the HDD 1 and the SD card 102. This is because the reproduction periods after the synchronization are results of the logical OR operation.

After the synchronization, both the HDD 1 and the SD card 102 have the same reproduction end position, which indicates a position at which the reproduction stopped the last time. The reproduction end position, therefore, is the resume information. For this reason, as is the case with Embodiment 1, the hard disk recorder 100 in Embodiment 5 can update the resume information to synchronize the resume position between the HDD 1 and the SD card 102.

As described above, in the present embodiment, periods during which the content was fast-forwarded in the SD card 102 are not recorded in the reproduction history information as a log. The periods during which the content was fast-forwarded in the SD card 102 can be shown by implementing the logical addition (OR) operation of the reproduction history information of the HDD 1 and the SD card 102. After this, the user can reproduce the content recorded in the HDD 1 for the periods during which the content was fast-forwarded in the SD card 102.

The user may view only interesting portions of a recorded content and skip CMs or uninteresting portions. The reproduction apparatus of the present embodiment creates the reproduction history information that shows only the periods during which the content was substantially reproduced, and further implement the logical addition (OR) of the reproduction periods to synchronize the reproduction periods between the different recording mediums. As a result, the user can recognize the state of reproduction periods comprehensively in regards with the HDD 1 and the SD card 102. That is to say, the user can recognize each period during which the user fast-forwarded or normally reproduced, for each of the HDD 1 and the SD card 102. This prevents a case where a user, who viewed a certain portion of a content while it was recorded in either the HDD 1 or the SD card 102, views the same portion again while it is recorded in the other.

### Embodiment 6

Embodiment 6 discloses a technology for recording a content into both the HDD 1 and the SD card 102. When the user programs the hard disk recorder 100 to record a broadcast content in advance, the recording control unit 16 in the present embodiment receives from the user a specification of the recording start date/time and the recording end date/time, and also receives a specification of a recording destination that is selected from (i) only the HDD 1, (ii) only the SD card 102, and (iii) both the HDD 1 and the SD card 102.

When the user selects (iii) both the HDD 1 and the SD card 102 as the recording mediums to which a content is recorded, the content is recorded into both recording mediums. This eliminates the user's needs to copy a recorded content from the HDD 1 to the SD card 102. This arrangement therefore increases the convenience of the users.

### Embodiment 7

Embodiment 7 imposes a certain limit to the update of the resume information while in Embodiment 1, the resume information is updated unconditionally when the contents recorded in the HDD 1 and the SD card 102 have a sameness. That is to say, when it is judged that the contents recorded in the HDD 1 and the SD card 102 connected to the hard disk recorder 100 have a sameness, the reproduction control unit 18 in Embodiment 7 reproduces a recorded content that is recorded in either the HDD 1 or the SD card 102. When the reproduction control unit 18 reproduces a content recorded in the HDD 1, it starts the reproduction from a position indicated by the resume information of the HDD 1, and when it reproduces a content recorded in the SD card 102, it starts the reproduction from a position indicated by the resume information of the SD card 102. While reproducing, the reproduction control unit 18 waits for the user to eject the SD card 102 from the hard disk recorder 100. If the user does not perform an ejection operation, the reproduction control unit 18 continues the reproduction. If the user performs an ejection operation, the reproduction control unit 18, before the SD card 102 is ejected, overwrites the resume information of the HDD 1 with the resume information of the SD card 102, or overwrites the resume information of the SD card 102 with the resume information of the HDD 1.

As described above, according to the present embodiment, the synchronization of the resume information between the HDD 1 and the SD card 102 is prolonged until immediately before the SD card 102 is ejected from the hard disk recorder 100. This enables the hard disk recorder 100 to perform the synchronization only once. Also, synchronization or deletion can be performed immediately after the reproduction of the content in the SD card is completed. This is because at this point in time, the SD card is still connected to the card slot. Furthermore, when a plurality of users use the hard disk recorder 100, the resume information of the SD card can be used. This eliminates the needs to provide the resume information in the HDD 1, and simplifies the construction of the HDD 1.

In Embodiment 7, an ejection of the SD card 102 is used as a trigger to perform the synchronization of the resume information. However, a predetermined operation other than the ejection may be used as a trigger to perform the synchronization of the resume information. Also, an image may be displayed to notify the user of the fact.

### Embodiment 8

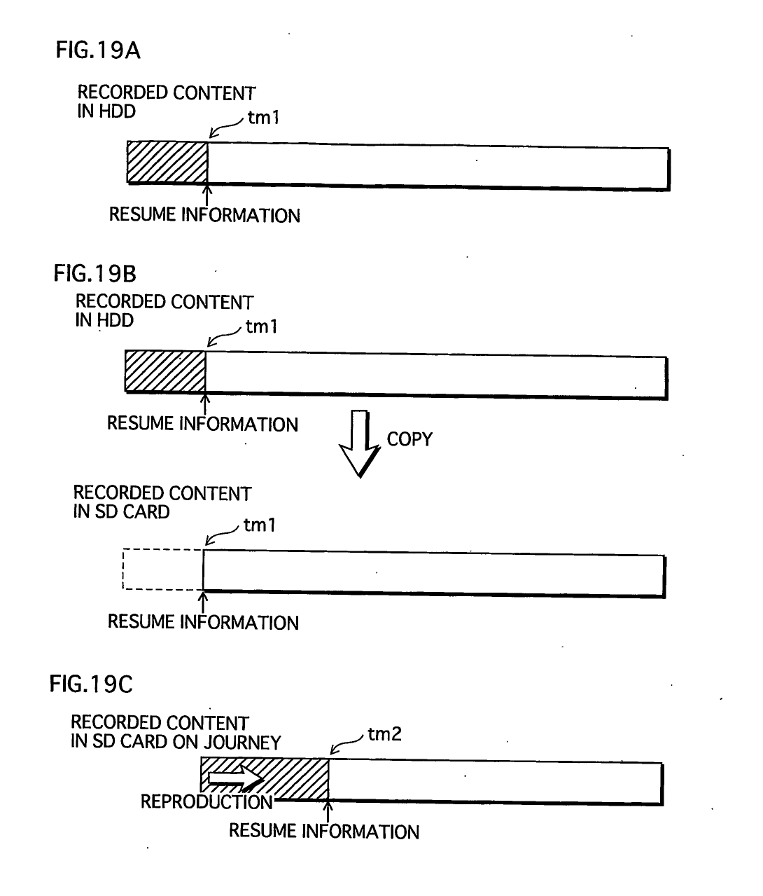

When, for example, the user goes out for a journey, the copy control unit 17 in Embodiment 8 copies a part of a recorded content from the HDD 1 to the SD card 102, while in Embodiment 1, the copy control unit 17 copies the whole recorded content from the HDD 1 to the SD card 102. FIGS. 19A-19C show how a recorded content is copied in Embodiment 8. FIGS. 19A-19C are illustrated in the same manner as FIGS. 12A-12C. Suppose that the user views the recorded content in the HDD 1 up to a time position tm1 and then instructs the copy control unit 17 to copy the recorded content to the SD card 102. Receiving the instruction, the copy control unit 17 copies a portion extending from the position tm1 to the end of the recorded content, to the SD card 102, as shown in the lower illustration of FIG. 19B. With such a copy in which a portion of a content that has already been viewed by the user is omitted, the amount of data to be recorded in the SD card 102 is decreased.

As described above, the present embodiment copies, from the HDD 1 to the SD card 102, a recorded content excluding a portion that has already been viewed by the user. This reduces as much time and amount of occupied space in the SD card 102 as is required for the copy.

### Embodiment 9

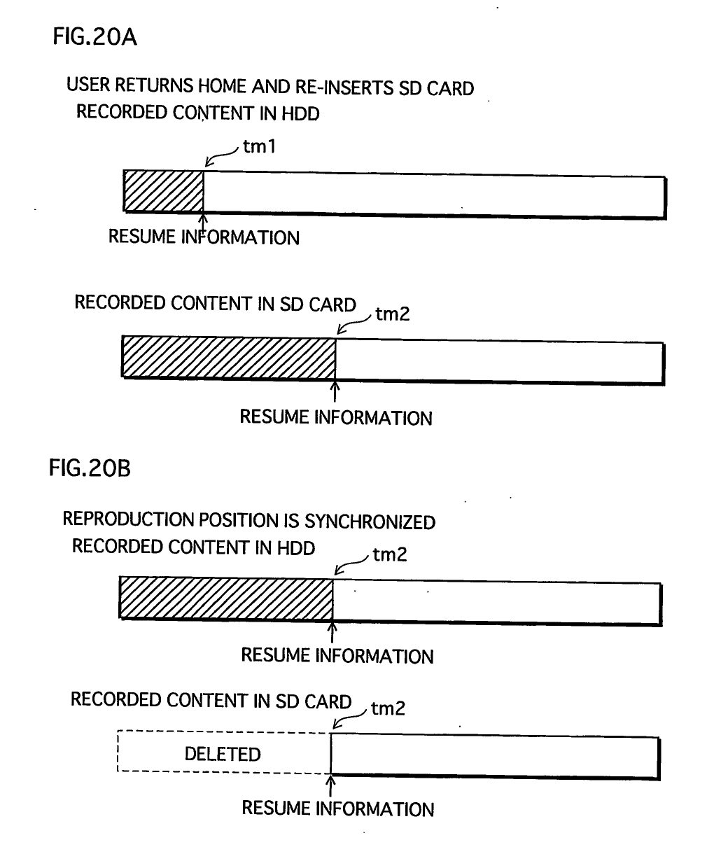

When the SD card 102 is connected to the hard disk recorder 100, the deletion control unit 19 in Embodiment 9 deletes a part of the content recorded in the SD card 102, while in Embodiment 2, the reproduction control unit 18 updates the resume information to synchronize the resume position between the HDD 1 and the SD card 102. FIGS. 20A-20B show the partial deletion of content in Embodiment 9. FIGS. 20A-20B are illustrated in the same manner as FIGS. 13A-13B. The processing procedure of the present embodiment shown in FIG. 20A is the same as that in Embodiment 1 shown in FIG. 13A, but the succeeding procedure is different. That is to say, after the resume information of the HDD 1 is updated to indicate the time position tm2 in synchronization of the resume position, the deletion control unit 19 in Embodiment 9 deletes a portion extending from the start to the position tm2 of the recorded content from the SD card 102. This reduces as much amount of occupied space in the SD card 102 as is deleted, enabling the SD card 102 to store as much amount of other data.

### Embodiment 10

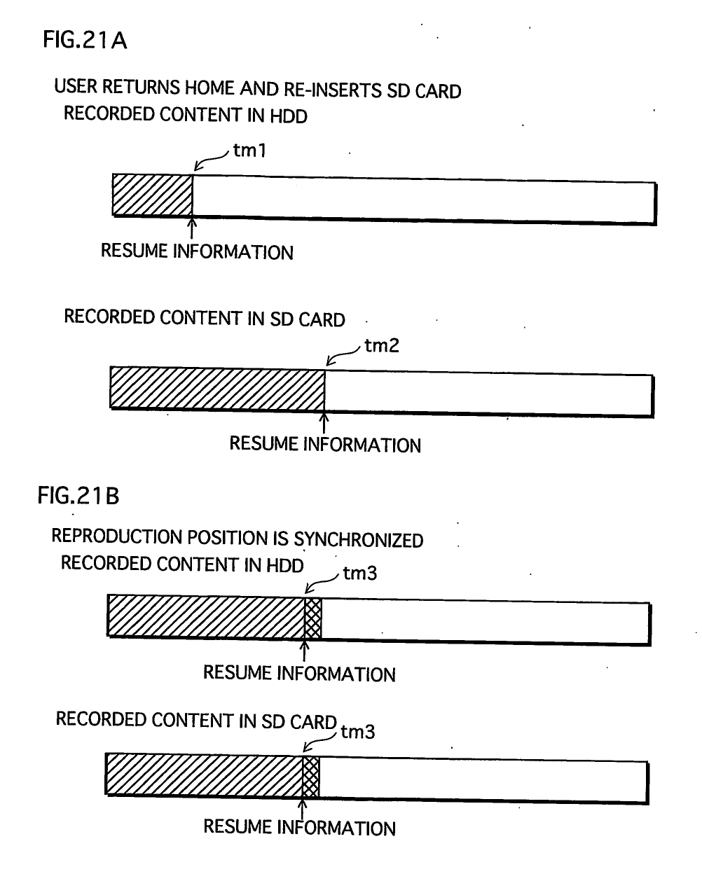

In Embodiment 1, the reproduction control unit 18 updates the resume information to synchronize the resume position between the HDD 1 and the SD card 102 after the SD card 102 is connected to the hard disk recorder-100. In this update, the resume information of one of the HDD 1 and the SD card 102 that specifies a time position that is earlier than that indicated by the resume position of the other is changed to indicate the time position of the other. In Embodiment 10, the resume information of both the HDD 1 and the SD card 102 is changed to indicate a time position that is obtained by subtracting a predetermined time period from one time position that is later than the other. FIGS. 21A-21B show the resume information synchronization process in Embodiment 10. FIGS. 21A-21B are illustrated in the same manner as FIGS. 13A-13B. The processing procedure of the present embodiment shown in FIG. 21A is the same as that in Embodiment 1 shown in FIG. 13A, but the succeeding procedure is different. That is to say, before the synchronization, as shown in FIG. 21A, the resume information of the SD card 102 indicates a time position tm2 at which the user stopped the reproduction the last time. However, after the synchronization, as shown in FIG. 21B, the resume information of both the HDD 1 and the SD card 102 indicates a time position tm3 which is predetermined time period α earlier than tm2 (that is to say, tm3=tm2−α). The “α” is of the order of several seconds to several tens of seconds. With such an arrangement, the user has to view a bit of overlapping portion of the recorded content when he/she resumes the viewing. This would refresh the user's memory and help him/her re-start the viewing smoothly, especially when, as is often the case, a long time has elapsed since the last viewing and some things have slipped out his/her memory. In contrast, with the arrangement of resuming the reproduction from a position that is a bit earlier than the exact position at which the user stopped viewing the last time, the user would be able to enjoy the relay viewing with refreshed memory.

### Embodiment 11

In Embodiment 1, the reproduction control unit 18 updates the resume information to synchronize the resume position between the HDD 1 and the SD card 102. In Embodiment 11, if a bookmark is set in a recorded content of the SD card 102, the reproduction control unit 18 copies the bookmark from the SD card 102 to the HDD 1.

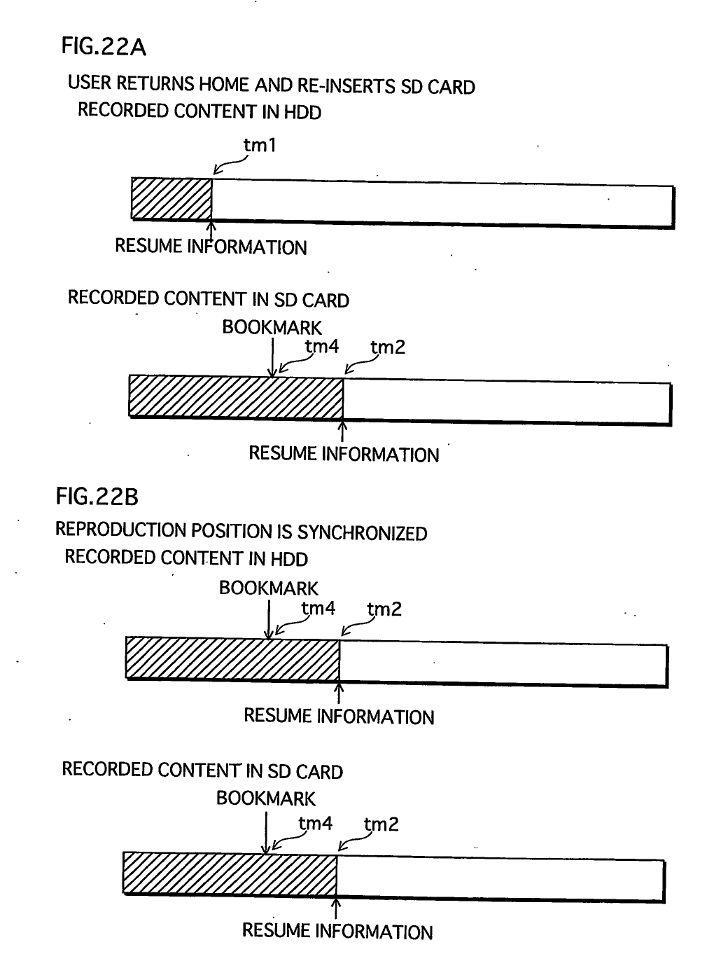

FIGS. 22A-22B show the bookmark setting process in Embodiment 11. FIGS. 22A-22B are illustrated in the same manner as FIGS. 13A-13B. FIG. 21A shows the state of the recording mediums immediately after the user returns home and re-insert the SC card 102 into the hard disk recorder 100. A bookmark indicating a time position tm4 is set in the recorded content of the SD card 102. The reproduction control unit 18 copies the bookmark to recorded content of the HDD 1.

With this arrangement, a bookmark indicating the time position tm4 is set in the recorded content of the HDD 1. This makes it possible for the user to view the recorded content of the HDD 1 with an immediate reproduction from the position tm4 indicated by the bookmark.

As described above, with the arrangement provided by the present embodiment, the user can view a desired scene of a recorded content as required using the bookmark that is copied from the SD card 102 to the HDD 1. This enables the user, for example, to put a bookmark onto a favorite scene in a recorded content while scanning the low-quality-image recorded content of the SD card 102, and re-view the favorite scene at his/her leisure in the high-quality-image recorded content of the HDD 1. This makes full use of the relay viewing.

It should be noted here that the reproduction control unit 18 can also copy a bookmark from the HDD 1 to the SD card 102.

### Embodiment 12

Embodiment 12 relates so a recording format of the recorded contents and the resume information. Such a recording format is classified into two formats: a recording format in which a pair of a recorded content and resume information is stored as one file; and a recording format in which a recorded content and resume information are stored separately as different files.

In the latter case where a recorded content and resume information are stored separately as different files, the file names are used to correlate a recorded content with a piece of resume information. In general, a file name is composed of a “file body” and an “extension”. Accordingly, it is possible to correlate a recorded content with a piece of resume information by creating file names that have a file body in common. It is also possible to correlate a recorded content with a piece of resume information by storing the files of them in a same directory.

The following describes the processes performed by the copy control unit 17 and the reproduction control unit 18 when a pair of a recorded content and resume information is stored in a same file in the HDD 1.

The copy control unit 17 copies the file to the SD card 102.

The reproduction control unit 18 updates the resume information that is stored in the same file together with a target recorded content in both the HDD 1 and the SD card 102 to synchronize the resume position between the HDD 1 and the SD card 102.

The following describes the processes performed by the copy control unit 17 and the reproduction control unit 18 when a recorded content and resume information are stored separately as different files in the HDD 1.

The copy control unit 17 copies two files having file names having a file body in common, to the SD card 102.

The reproduction control unit 18 updates the resume information that is stored in the files with file names having the same file body as the files containing target recorded contents in both the HDD 1 and the SD card 102 to synchronize the resume position between the HDD 1 and the SD card 102.

As described above, the present embodiment increases the efficiency of copying or updating the resume information since it enables a pair of a recorded content and resume information to be stored in a file or in separate files correlated with each other.

### Embodiment 13

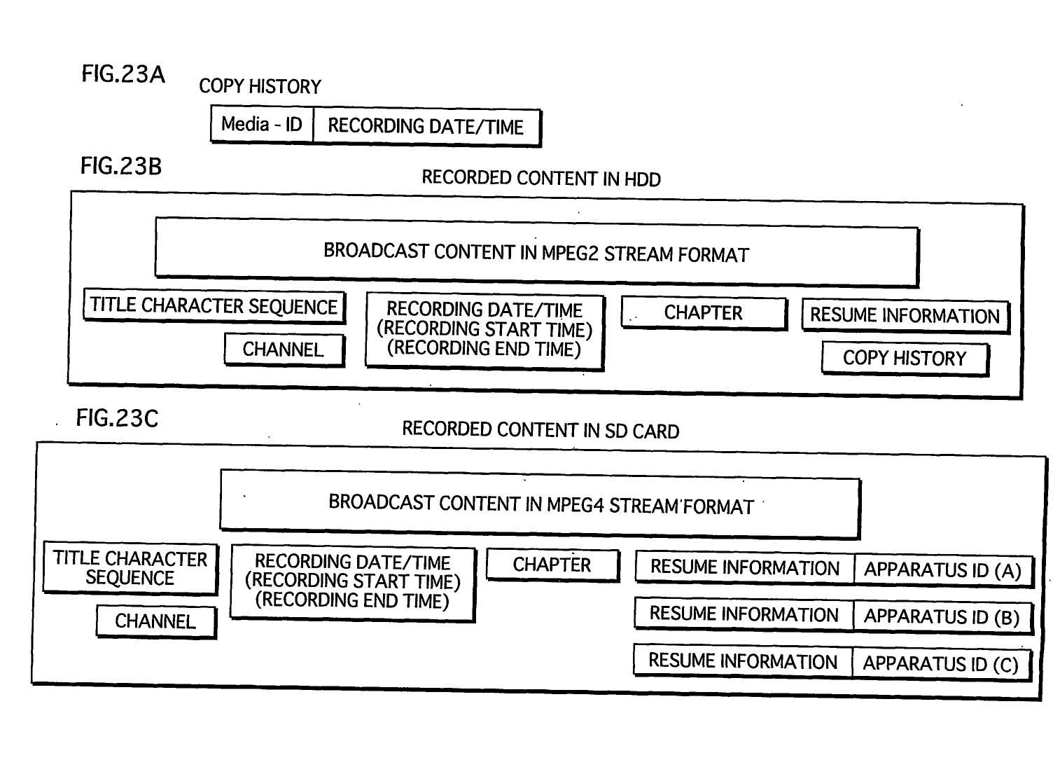

Embodiment 13 discloses a construction in which a plurality of users share one SD card 102, while Embodiment 2 discloses a multiuser support which deals with a plurality of users who each own an SD card 102. FIGS. 23A-23C show the structure of the resume information for achieving the feature in which a plurality of users share one SD card 102. The structure of the resume information shown in FIGS. 23A-23C differs from that in Embodiment 1 in that the SD card 102 stores a plurality of pieces of resume information in correspondence with a content that is also stored in the SD card 102. Each piece of resume information has an apparatus ID identifying an apparatus that is to resume a reproduction in accordance with the piece of resume information. In an example case shown in FIGS. 23A-23C, the first piece of resume information has an apparatus ID indicating apparatus A. In this case, when the SD card 102 is connected to the apparatus A, the apparatus A resumes a reproduction from a position indicated by the first piece of resume information.

Similarly, the second piece of resume information has an apparatus ID indicating apparatus B. In this case, when the SD card 102 is connected to the apparatus B, the apparatus B resumes a reproduction from a position indicated by the second piece of resume information.

With such an arrangement, the apparatuses A and B can resume reproduction of a recorded content from different positions in accordance with different pieces of resume information, respectively. As a result, for example, if a father owns the apparatus A and his son owns apparatus B, the father and the son can record the same content into the SD card 102 and reproduce the recorded content from different positions, respectively.

To record the above-described resume information into the SD card 102, the copy control unit 17 of the present embodiment judges whether a recorded content to be copied into the SD card 102 has already been recorded in the SD card 102. If it is judged that the recorded content is not recorded in the SD card 102, the copy control unit 17 of the present embodiment processes in the same manner as Embodiment 1. If it is judged that the recorded content has already been recorded in the SD card 102, the copy control unit 17 of the present embodiment writes a piece of resume information that has an apparatus ID of the hard disk recorder 100 that contains the copy control unit 17 itself, into the SD card 102.

To achieve a reproduction in accordance with such resume information of the present embodiment, the reproduction control unit 18 of the present embodiment judges whether a recorded content to be reproduced has a piece of resume information that has the apparatus ID of the hard disk recorder 100 that contains the reproduction control unit 18 itself. If the judgment result is in the positive, the reproduction control unit 18 of the present embodiment updates either the resume information in the HDD 1 in the current hard disk recorder 100 or the piece of resume information in the SD card 102 correlated with the current hard disk recorder 100, to synchronize the resume position between the HDD 1 and the SD card 102.

As described above, the present embodiment enables a plurality of users to share an SD card 102 and resume reproduction of a recorded content in the SD card 102 respectively from different positions since each hard disk recorder 100 of a user resumes reproduction of a recorded content in the SD card 102 in accordance with a piece of resume information for the hard disk recorder 100 of the user, and the update for synchronization between the SD card 102 and the HDD 1 is performed for each piece of resume information that is correlated with a hard disk recorder 100 of a user.

The present embodiment provides an advantageous effect that a plurality of users can share an SD card and resume reproduction respectively from different positions, eliminating the needs to record as many copies of a content in the SD card as the number of users who view the content.

Supplementary Notes

Up to now, various embodiments of the present invention have been described. The above-described embodiments are expected to provide best effects at present. However, the present invention can be modified in many other ways. The following are representative ones.

(A) The hard disk recorder 100 in Embodiments 1-13 are used while it is connected to the television 101. However, the hard disk recorder 100 and a display (for example, a liquid crystal display) may be achieved as one piece. Also, the hard disk recorder 100 in Embodiment 1 may be a computer having an audio-visual function. In the above-described embodiments, the hard disk recorder 100 contains a hard disk drive, an MPEG2 encoder or the like that are embedded therein. However, the microcomputer may not contain these units, but may be connected to these units via an IEEE1394 connector. In addition, the hard disk recorder 100 may consist of only the microcomputer system 14 that constitutes an essential part of the hard disk recorder 100.

An act of manufacturing the hard disk recorder 100 having the construction disclosed in Embodiments 1-13 in any of the above-described forms is regarded as working of the present invention. An act of transferring, lending, or importing the hard disk recorder 100 is also regarded as working of the present invention regardless of whether such an act is done for profit or for free, where transfers for profit are sales, and transfers for free are gifts. An act of holding a product or semifinished product of the hard disk recorder 100 and offering, through an over-the-counter display, a catalog, distribution of a pamphlet or the like, the transferring or lending of the product or semifinished product to the general user is also regarded as working of the present invention.

(B) The program shown in FIGS. 7-10 is regarded as an independent invention since the program uses concrete hardware resources such as a CPU, an MPEG encoder, a hard disk drive or the like for the information processing. In Embodiments 1-13, the program is embedded in the hard disk recorder 100. However, the program may be separated from the hard disk recorder 100 and used as a separate entity to realize each feature of Embodiments 1-13, as working of the present invention. Such working of the present invention using the program as a separate entity is classified into, for example: (1) an act of manufacturing the program; (2) an act of transferring the program either for profit or for free; (3) an act of lending the program; (4) an act of importing the program; (5) an act of providing the public with the program via a bi-directional electronic communication; and (6) an act of offering, through an over-the-counter display, a catalog, distribution of a pamphlet or the like, transferring or lending of the program to the general user.

The act of providing the public with the program via a bi-directional electronic communication in (5) above is classified into, for example: (1) an act of sending the program to a user for use thereof (a program download service); and (2) an act of sending only a function of the program to a user via an electronic communication line, while retaining the program at the provider (a function provision type ASP service).

(C) The time-related elements that are executed in time series in the steps of the flow charts shown in FIGS. 7-10 are considered to be essential in identifying the present invention. The procedures shown in the flow charts disclose a use form of the reproduction method. It is considered therefore that the procedures shown in the flowcharts disclose how the reproduction method of the present invention is worked. It is therefore needless to say that implementing the steps of the flowcharts in time series to achieve an object of the present invention, obtaining the actions and effects of the present invention, is regarded as working of the present invention.

(D) In Embodiments 1-13, a recording medium embedded in the hard disk recorder 100 is a hard disk. However, since the physical properties of the hard disk do not much contribute to the actions and effects of the present invention, another recording medium may be adopted in so far as the recording medium has as much capacity to record broadcast programs as the hard disk. For example, an optical disc such as DVD-R, DVD-RW, DVD-RAM, DVD+R, DVD+RW, CD-R, CD-RW, or Blue-ray Disc may be used in place of the hard disk. Also, a magneto-optical disk such as PD or MO may be used in place of the hard disk.

Also, in Embodiments 1-13, a mobile disk is an SD card. However, a semiconductor memory card such as compact flash card, smart media, memory stick, multimedia card, or PCMCIA card may be used in place of the SD card. Also, a magnetic recording disk such as flexible disk, SuperDisk, Zip, or Click, or a removable hard disk drive such as ORB, Jaz, SparQ, SyJet, EZFley, or micro-drive may be used in place of the SD card. Also, the SD viewer itself may be used as a mobile medium that contains a memory or a hard disk.

(E) The video contents used in Embodiments 1-13 are VOBs obtained by encoding analog broadcast video signals. However, the video contents may be stream data composed of transport streams obtained through digital broadcasts.

Also, the video contents may be obtained by encoding analog/digital video signals recorded in video tapes. Also, the video contents may be obtained by encoding analog/digital video signals that are directly read from a video camera. Also, the video contents may be digital works such as movies distributed by means of recording mediums, or digital works distributed from distribution servers.

(F) In Embodiments 1-13, the reproduction apparatus receives specification of a recorded content selected by the user through a user's operation on a remote controller. However, the reproduction apparatus may receive user's specification through an input device such as a keyboard, touch panel, mouse, pad, or track ball. In this case, the user may use a click operation or a drag operation for the specification.

### INDUSTRIAL APPLICABILITY

The reproduction apparatus of the present invention enhances the commercial value of the hard disk recorder or the like since the present invention enhances the linkage between the hard disk recorder and the SD card. This enables attractive products to be introduced on the market. The present invention therefore has high industrial applicability in the commercial product industry.

1. A reproduction apparatus comprising:
an embedded recording medium storing therein a first video content and first resume position information that indicates a resume position of the first video content;
a connecting unit operable to connect to a mobile recording medium;
a judging unit operable to, if the mobile recording medium connected to the connecting unit stores therein a second video content and second resume position information that indicates a resume position of the second video content, judges whether the first and second video contents have a sameness;
an update unit operable to, if the judging unit judges that the first and second video contents have the sameness, update either the first or the second resume position information to synchronize the resume position of the embedded recording medium with the resume position of the mobile recording medium; and
a reproduction unit operable to reproduce the first or second video content starting from the resume position indicated by the first or second resume position information after the update.

2. The reproduction apparatus of claim 1, wherein
the embedded recording medium stores therein first recording date/time information that indicates a recording date/time of the first video content,
the second video content stored in the mobile recording medium is a copy of the first video content stored in the embedded recording medium,
the mobile recording medium stores therein second recording date/time information that indicates a recording date/time at which an original of the second video content was recorded in the embedded recording medium, and
the judgment performed by the judging unit includes a judgment on whether the recording date/time indicated by the first recording date/time information matches the recording date/time indicated by the second recording date/time information.

3. The reproduction apparatus of claim 1 further comprising
a copying unit operable to copy the first video content stored in the embedded recording medium, wherein
the embedded recording medium stores therein an identifier of a recording medium to which the first video content is copied, and
the judgment performed by the judging unit includes a judgment on whether the identifier stored in the embedded recording medium matches an identifier of the mobile recording medium connected to the connecting unit.

4. The reproduction apparatus of claim 3, wherein
the embedded recording medium stores therein a plurality of identifiers of a plurality of recording mediums to which the first video content is copied,
each of the plurality of identifiers is correlated with a piece of resume position information which corresponds to one of a plurality of users,
the judging unit judges that the first and second video contents have the sameness if an identifier of the mobile recording medium connected to the connecting unit is included in the plurality of identifiers stored in the embedded recording medium, and
if the judging unit judges that the first and second video contents have the sameness, the update unit updates either the first resume position information or the second resume position information, which is correlated with the identifier of the recording medium connected to the connecting unit.

5. The reproduction apparatus of claim 1 further comprising
a registering unit operable to register, as a chapter, the resume position indicated by one of the first and the second resume position information stored in one of the embedded recording medium and the mobile recording medium, with the other of the embedded recording medium and the mobile recording medium, and
if a user requests an immediate reproduction from the registered chapter using a chapter jump function, the reproduction unit reproduces the first or second video content starting from the registered chapter.

6. The reproduction apparatus of claim 1, wherein
when the mobile recording medium connected to the connecting unit stores therein deletion information that indicates that the second video content has been deleted, the judging unit further judges whether the deleted second video content has the sameness with the first video content stored in the embedded recording medium, and
the reproduction apparatus further comprises
a deleting unit operable to delete the first video content from the embedded recording medium if the judging unit judges that the deleted second video content has the sameness with the first video content.

7. The reproduction apparatus of claim 1 further comprising:
a resume position judging unit operable to judge whether the resume position after the synchronization indicates an end of the first or second video content; and
a deleting unit operable to delete one or both of the first and second video contents from one or both of the embedded and mobile recording mediums if the resume position judging unit judges that the resume position after the synchronization indicates the end of the first or second video content.

8. The reproduction apparatus of claim 1, wherein
after the mobile medium is newly connected to the connecting unit, the reproduction unit reproduces either the first or second video content stored in the embedded or mobile recording medium, from the resume position indicated by the second resume position information stored in the newly connected mobile medium, and
if a user performs an operation for disconnecting the mobile medium from the reproduction apparatus, the update unit updates either the first or the second resume position information to synchronize the resume position of the embedded recording medium with the resume position of the mobile recording medium.

9. The reproduction apparatus of claim 1, wherein
the second video content stored in the mobile medium is a copy of a portion extending from the resume position indicated by the first resume position information to an end of the first video content.

10. The reproduction apparatus of claim 1 further comprising
a copying unit operable to copy, from the embedded recording medium to a mobile medium connected to the connecting unit, (i) a portion of a video content stored in the embedded recording medium that extends from a resume position indicated by resume position information stored in the embedded recording medium to an end of the video content and (ii) a recording date/time of the video content, and
the judgment performed by the judging unit includes a judgment on whether the recording date/time stored in the embedded recording medium matches a recording date/time stored in the mobile recording medium connected to the connecting unit.

11. The reproduction apparatus of claim 1 further comprising
a deleting unit operable to, if the update unit updates either the first or the second resume position information, delete a portion extending from a start to a resume position from one or both of the first and second video contents.

12. The reproduction apparatus of claim 1, wherein
each piece of resume position information indicates a resume position of a video content using a reproduction time of the video content, and
if the judging unit judges that the first and second video contents have the sameness, the update unit subtracts a predetermined time period from a reproduction time indicated by either the first or the second resume position information, then updates both the first and second resume position information to indicate a reproduction time that is a result of the subtraction.

13. The reproduction apparatus of claim 1, wherein
the mobile recording medium stores therein bookmark information that indicates a position in the second video content as a bookmark,
the update unit, when updating either the first or the second resume position information to for the synchronization, copies the bookmark information from the mobile recording medium to the embedded recording medium, and
if a user performs a predetermined operation, the reproduction unit reproduces the first video content starting from a position indicated by the copied bookmark information as the bookmark.

14. The reproduction apparatus of claim 1, wherein
a video content and a piece of resume position information are contained as a pair in a same file in the embedded recording medium,
the reproduction apparatus further comprises
a copying unit operable to copy the file containing the pair of the video content and the piece of resume position information, from the embedded recording medium to the mobile recording medium, and
if the mobile recording medium connected to the connecting unit has the same file as that stored in the embedded recording medium, the update unit updates a piece of resume position information contained in the same file stored in either the embedded recording medium or the mobile recording medium to synchronize the resume position of the embedded recording medium with the resume position of the mobile recording medium.

15. The reproduction apparatus of claim 1, wherein
a video content and a piece of resume position information making a pair are separately contained in different files in the embedded recording medium,
the reproduction apparatus further comprises
a copying unit operable to copy the files respectively containing the video content and the piece of resume position information, from the embedded recording medium to the mobile recording medium, and
the update unit operable to, if the judging unit judges that the first and second video contents have the sameness, update either the first or the second resume position information, which is contained in a different file from a file containing the first or second video content, to synchronize the resume position of the embedded recording medium with the resume position of the mobile recording medium.

16. The reproduction apparatus of claim 1, wherein
the mobile recording medium stores therein a plurality of pieces of resume position information which are respectively correlated with a plurality of apparatus identifiers, and
the update unit updates either the first resume position information or the second resume position information, which is correlated with an apparatus identifier of the reproduction apparatus.

17. A computer-readable program which causes a computer, which includes an embedded recording medium storing therein a first video content and first resume position information that indicates a resume position of the first video content, to reproduce a video content, the computer-readable program causing the computer to perform:
a detecting step for detecting whether a mobile recording medium is connected to the computer;
a judging step for, if the mobile recording medium connected to the computer stores therein a second video content and second resume position information that indicates a resume position of the second video content, judging whether the first and second video contents have a sameness;
an update step for, if the judging step judges that the first and second video contents have the sameness, updating either the first or the second resume position information to synchronize the resume position of the embedded recording medium with the resume position of the mobile recording medium; and
a reproduction step for reproducing the first or second video content starting from the resume position indicated by the first or second resume position information after the update.

18. An integrated circuit provided a recording apparatus that has (a) an embedded recording medium storing therein a first video content and first resume position information that indicates a resume position of the first video content, and (b) a connecting unit operable to connect to a mobile recording medium, the integrated circuit comprising:
a judging unit operable to, if the mobile recording medium connected to the connecting unit stores therein a second video content and second resume position information that indicates a resume position of the second video content, judges whether the first and second video contents have a sameness;
an update unit operable to, if the judging unit judges that the first and second video contents have the sameness, update either the first or the second resume position information to synchronize the resume position of the embedded recording medium with the resume position of the mobile recording medium; and
a reproduction unit operable to reproduce the first or second video content starting from the resume position indicated by the first or second resume position information after the update.
